(19) United States
(12) Patent Application Publication
(10) Pub. No.: US 2025/0348557 A1
(43) Pub. Date: Nov. 13, 2025

(54) CLASSIFICATION MODEL TRAINING METHOD AND APPARATUS

(71) Applicant: TENCENT TECHNOLOGY (SHENZHEN) COMPANY LIMITED, Shenzhen (CN)

(72) Inventors: Bo LIN, Shenzhen (CN); Zhiyuan REN, Shenzhen (CN); Yongjia XIN, Shenzhen (CN); Kaiyuan CUI, Shenzhen (CN); Zhaowei KANG, Shenzhen (CN)

(21) Appl. No.: 19/222,469

(22) Filed: May 29, 2025

Related U.S. Application Data
(63) Continuation of application No. PCT/CN2023/130757, filed on Nov. 9, 2023.

(30) Foreign Application Priority Data
Apr. 18, 2023 (CN) 202310458965.4

(51) Int. Cl. G06F 18/2415; G06F 18/213

(52) U.S. Cl. CPC G06F 18/2415; G06F 18/213

(57) ABSTRACT

This application discloses a classification model training method and apparatus, an electronic device, a computer-readable storage medium, and a computer program product. The method is performed by an electronic device and includes obtaining one original sample content, one labeled sample content, and a classification model; selecting at least one target sample content from the original sample content and constructing an expected content type corresponding to the target sample content; classifying the target sample content to obtain an actual content type of the target sample content; adjusting parameters of the classification model based on the actual content type; classifying the labeled sample content by using the adjusted classification model to obtain an actual content type of the labeled sample content; and updating a parameter of the adjusted classification model according to the actual content type for classifying a content to be processed to obtain a content type.

### RELATED APPLICATIONS

This application is a continuation of PCT Application No. PCT/CN2023/130757, filed on Nov. 9, 2023, which in turn claims priority to Chinese Patent Application No. 202310458965.4, filed on Apr. 18, 2023, which are both incorporated herein by reference in their entirety.

### FIELD OF THE TECHNOLOGY

This application relates to the field of computer technologies, and in particular, to a classification model training method and apparatus, an electronic device, a computer-readable storage medium, and a computer program product.

### BACKGROUND OF THE DISCLOSURE

With the development of network information technologies, the amount of content information on the Internet increases sharply. To analyze contents of interest among massive contents, information of the contents needs to be processed. Content classification is a key technology for processing content information at a larger scale, and plays a vital role in information processing. Content classification refers to classifying content data according to a classification system or standard, to obtain a corresponding content type. Generally, a content classification model may be trained by using an artificial intelligence (AI) technology, to obtain a trained content classification model, and a content to be processed is inputted to the trained content classification model to obtain a content classification result.

However, often, a large amount of manually labeled data usually needs to be used as a training set to train the content classification model. Specifically, tag information needs to be added to a sample content. The tag information includes an expected classification result corresponding to the sample content. Then, the sample content is classified by using the content classification model, to obtain a predicted classification result. A parameter of the content classification model is updated according to the predicted classification result and the tag information carried in the sample content. Current classification technology relies on a large number of tagged samples, and is based on supervised training on a tagged big data set. As such, a large number of human and material resources need to be consumed to label the sample content, leading to high training costs. In addition, a data labeling process is usually very long, leading to low training efficiency. However, if a large number of labeled training samples are not used to perform model training, difficult model learning is caused by a small quantity of samples, leading to a poor model classification results.

### SUMMARY

Embodiments of this application provide a classification model training method and apparatus, an electronic device, a computer-readable storage medium, and a computer program product. According to the embodiments of this application, training efficiency of a model can be improved, and training costs can be reduced. In addition, the model can converge well, thereby improving classification accuracy of the model.

One aspect of this application provides a classification model training method. The method is performed by an electronic device. The method includes: obtaining at least one original sample content and labeled sample content, and obtaining a classification model, the labeled sample content carrying an expected content type, and the classification model comprising a feature extraction module and a classification module; selecting at least one target sample content from the original sample content based on the expected content type corresponding to the labeled sample content and at least one content tag corresponding to the labeled sample content, and constructing an expected content type corresponding to the target sample content; classifying the target sample content by using the classification model to obtain an actual content type corresponding to the target sample content; adjusting parameters of the feature extraction module and the classification module of the classification model based on the actual content type corresponding to the target sample content and the expected content type corresponding to the target sample content, to obtain an adjusted classification model; classifying the labeled sample content by using the adjusted classification model, to obtain an actual content type corresponding to the labeled sample content; and updating a parameter of a classification module of the adjusted classification model according to the actual content type corresponding to the labeled sample content and the expected content type corresponding to the labeled sample content, to obtain a target classification model, the target classification model being configured for classifying a content to be processed to obtain a content type of the content to be processed.

Another aspect of this application provides an electronic device, including a processor and a memory. The memory has computer-executable instructions stored. The processor loads the computer-executable instructions, to perform the classification model training method provided in this embodiment.

Another aspect of this application further provides a non-transitory computer-readable storage medium, having computer-executable instructions stored thereon. The computer-executable instructions, when executed by a processor, implement the classification model training method provided in this embodiment.

In embodiments consistent with the present disclosure, a target sample content for training a target task may be mined by using a labeled sample content, so that the quantity of training samples is greatly increased. Accordingly, efficiency of obtaining a training sample can be improved, and not all training samples need to be labeled, thereby greatly improving training efficiency and reducing training costs. In addition, multi-stage training and learning are performed. First, an overall parameter of a model is adjusted based on the mined target sample content. Then, a parameter of a classification module is adjusted by using the labeled sample content. Accordingly, a multi-stage progressive learning method enables the model to converge well, so that classification accuracy of a target classification model obtained through training is higher.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1a is a schematic diagram of a scene of a classification model training method according to an embodiment of this application.

FIG. 1b is a flowchart of a classification model training method according to an embodiment of this application.

FIG. 1c is an illustration diagram of a classification model training method according to an embodiment of this application.

FIG. 1d is another illustration diagram of a classification model training method according to an embodiment of this application.

FIG. 1e is another illustration diagram of a classification model training method according to an embodiment of this application.

FIG. 1f is another illustration diagram of a classification model training method according to an embodiment of this application.

FIG. 1g is another illustration diagram of a classification model training method according to an embodiment of this application.

FIG. 1h is another illustration diagram of a classification model training method according to an embodiment of this application.

FIG. 1i is another illustration diagram of a classification model training method according to an embodiment of this application.

FIG. 1j is another illustration diagram of a classification model training method according to an embodiment of this application.

FIG. 1k is another illustration diagram of a classification model training method according to an embodiment of this application.

FIG. 2 is another flowchart of a classification model training method according to an embodiment of this application.

FIG. 3 is a schematic diagram of a structure of a classification model training apparatus according to an embodiment of this application.

FIG. 4 is a schematic diagram of a structure of an electronic device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person skilled in the art based on the embodiments of this application without creative efforts shall fall within the protection scope of this application.

Embodiments of this application provide a classification model training method and a related device. The related device may include a classification model training apparatus, an electronic device, a computer-readable storage medium, and a computer program product. The classification model training apparatus may specifically be integrated in an electronic device. The electronic device may be a terminal, a server, or another device.

The classification model training method in this embodiment may be performed on the terminal, or may be performed on the server, or may be performed by the terminal and the server together. The foregoing examples are not to be construed as limiting this application.

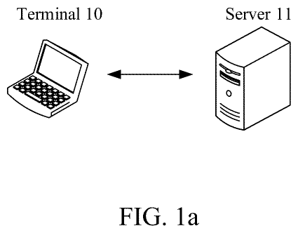

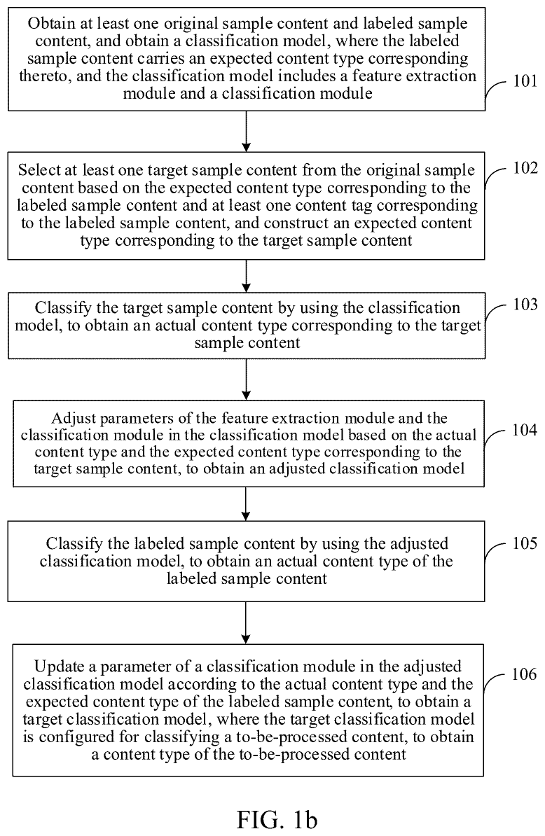

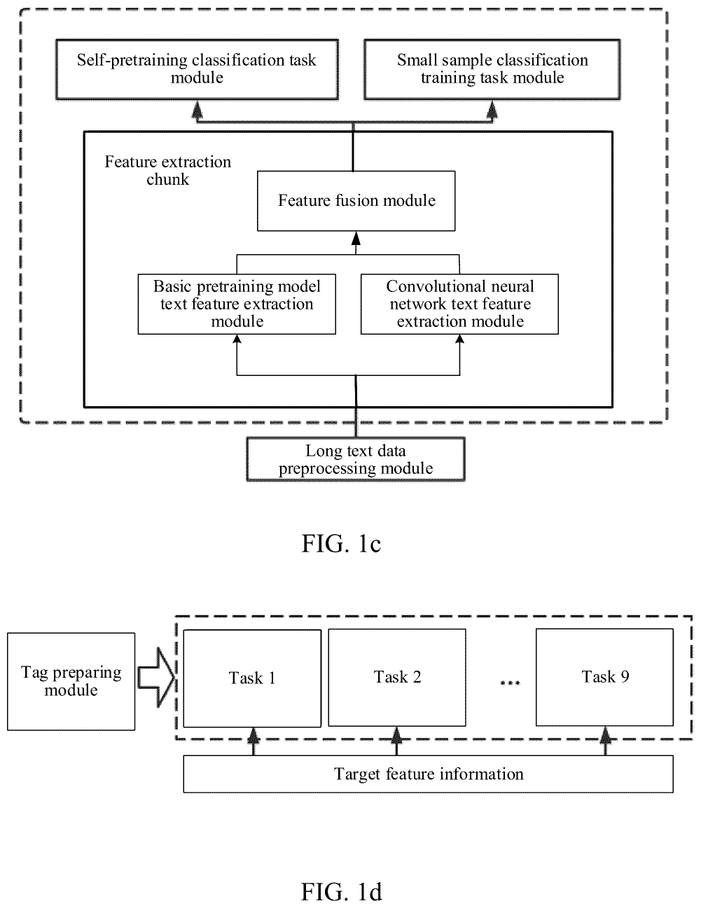

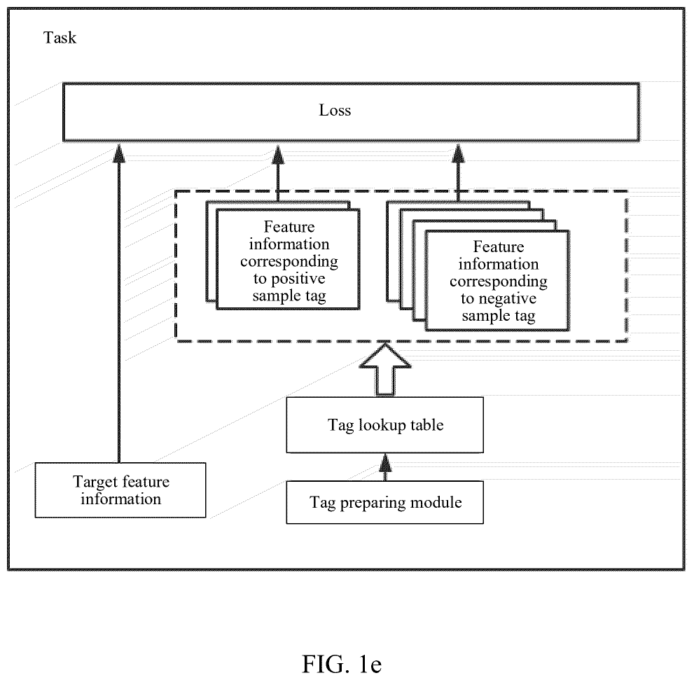

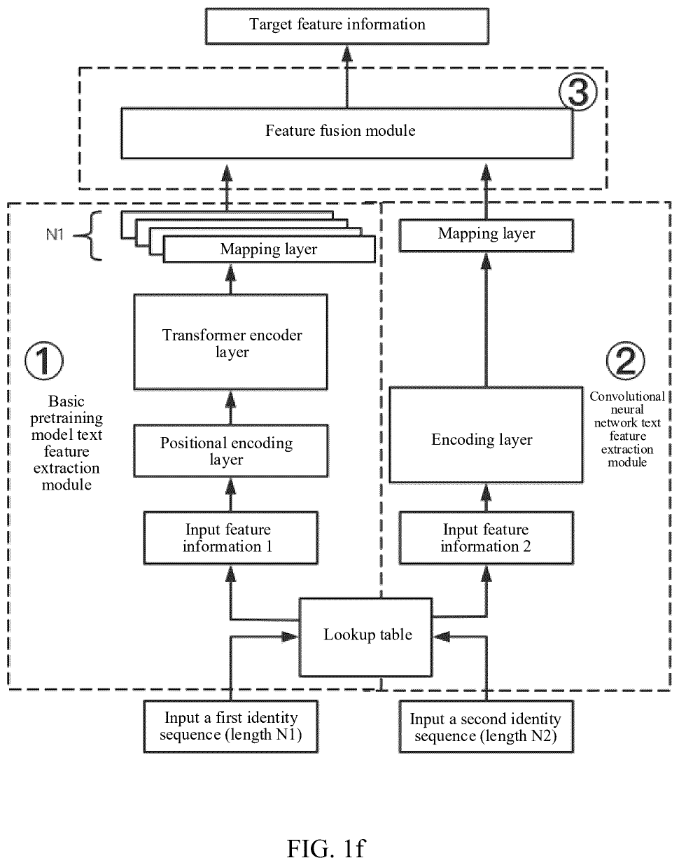

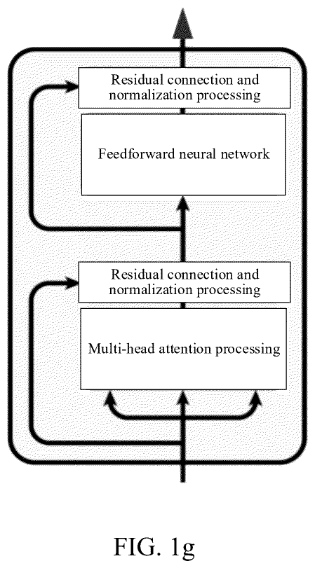

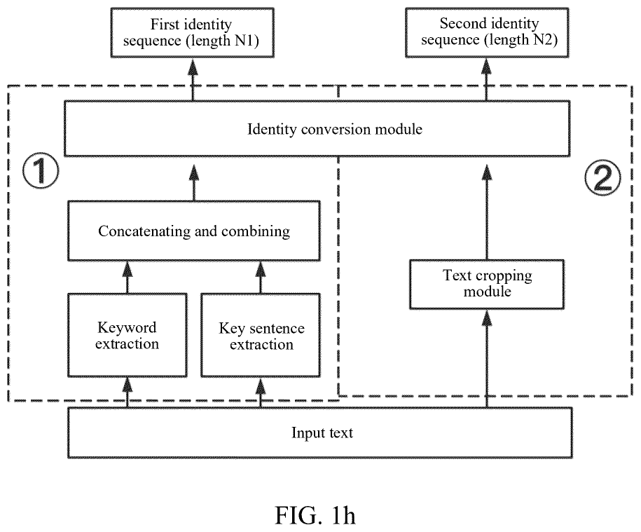

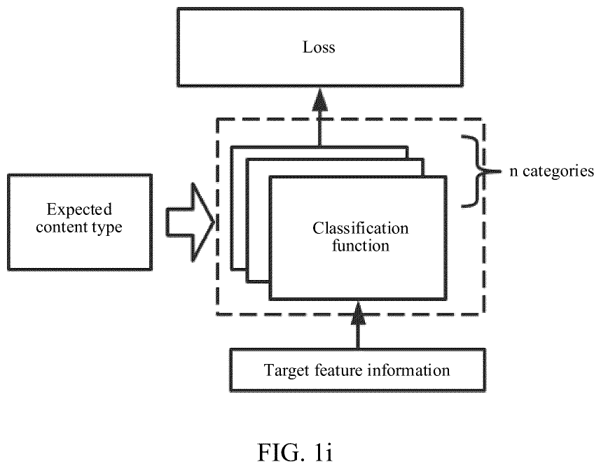

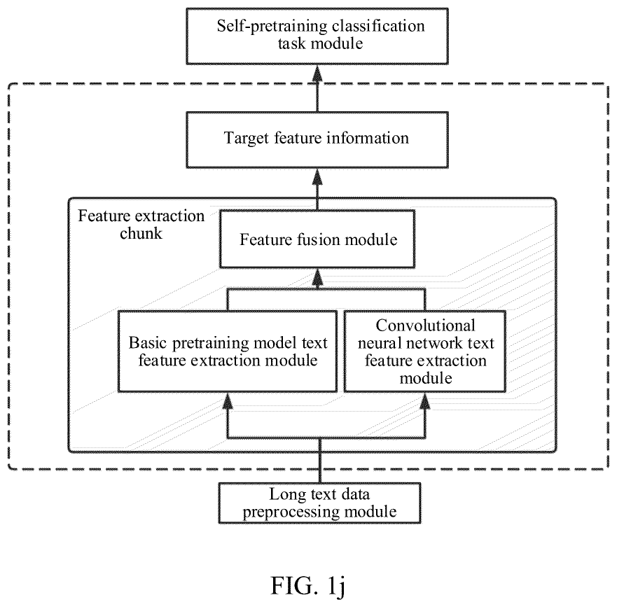

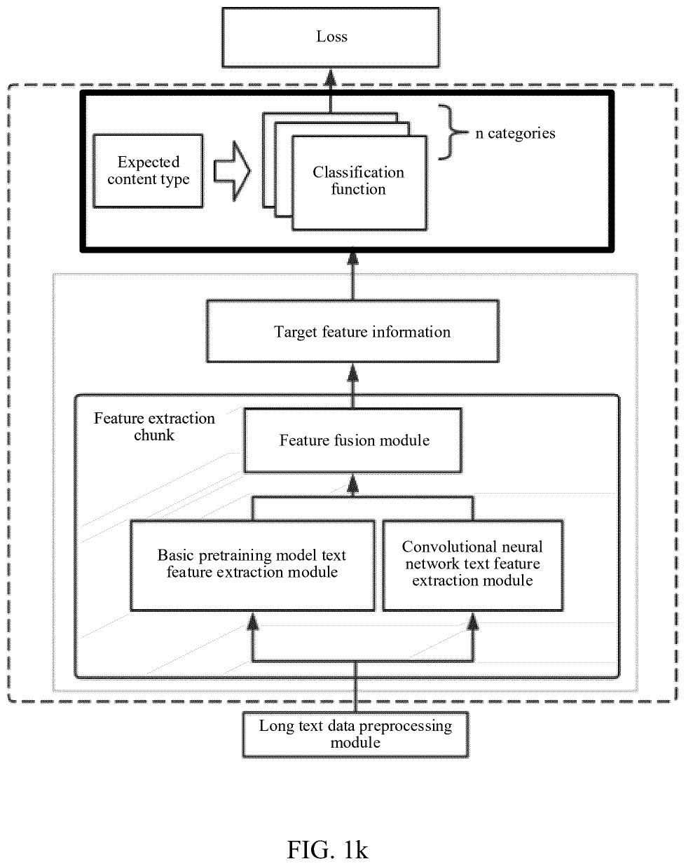

As shown in FIG. 1a, the classification model training method that is performed by the terminal and the server together is used. A classification model training system provided in an embodiment of this application includes a terminal 10, a server 11, and the like. The terminal 10 and the server 11 are connected by using a network, for example, are connected by using a wired or wireless network. A classification model training apparatus may be integrated in the server.

The server 11 may be configured to: obtain at least one original sample content and labeled sample content, and obtain a classification model, where the labeled sample content carries an expected content type corresponding thereto, and the classification model includes a feature extraction module and a classification module; select at least one target sample content from the original sample content based on the expected content type corresponding to the labeled sample content and at least one content tag corresponding to the labeled sample content, and construct an expected content type corresponding to the target sample content; classify the target sample content by using the classification model, to obtain an content type corresponding to the target sample content; adjust parameters of the feature extraction module and the classification module in the classification model based on the content type and the expected content type corresponding to the target sample content, to obtain an adjusted classification model; classify the labeled sample content by using the adjusted classification model, to obtain an content type of the labeled sample content; and update a parameter of a classification module in the adjusted classification model according to the content type and the expected content type of the labeled sample content, to obtain a target classification model. The server 11 may be one server, a server cluster formed by a plurality of servers, or a cloud server. In the classification model training method or apparatus disclosed in this application, a plurality of servers may be grouped into a blockchain, and the servers are nodes on the blockchain.

The terminal 10 may be configured to: receive a trained target classification model transmitted by the server 11, where the target classification model is configured for classifying a content to be processed, to obtain a content type of the content to be processed. The terminal 10 may include a mobile phone, a smart voice interaction device, a smart home appliance, an in-vehicle terminal, an aircraft, a tablet computer, a laptop, or a personal computer (PC), and the like. The terminal 10 may be further provided with a client. The client may be an application client, a browser client, or the like.

Operations such as model training performed in the server 11 may alternatively be performed by the terminal 10.

The classification model training method provided in this embodiment relates to natural language processing (NLP) and machine learning (ML) in the field of AI.

AI is a theory, method, technology, and application system that uses a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making. The AI technology is a comprehensive discipline, and relates to a wide range of fields including both hardware-level technologies and software-level technologies. AI software technologies mainly include a computer vision technology, a speech processing technology, an NLP technology, ML/deep learning, autonomous driving, intelligent transportation, and other major directions.

NLP is an important direction in the field of computer science and the field of AI. NLP studies various theories and methods that can implement effective communication between people and computers by using natural languages. NLP is a comprehensive science of linguistics, computer science, and mathematics. Therefore, the study in this field relates to natural languages, namely, languages daily used by people, and therefore, the natural languages are closely related to linguistic studies. The NLP technologies generally include technologies such as text processing, semantic understanding, machine translation, robot question-answering, and knowledge graph.

ML is a multi-field inter-discipline, and relates to a plurality of disciplines such as a probability theory, statistics, an approximation theory, convex analysis, and an algorithm complexity theory. ML specializes in studying how a computer simulates or implements a human learning behavior to obtain new knowledge or skills, and to reorganize an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

Detailed descriptions are separately provided below. A description order of the following embodiments is not used as a limitation on the priority order of the embodiments.

This embodiment will be described from the perspective of a classification model training apparatus. The classification model training apparatus may specifically be integrated in an electronic device. The electronic device may be a server, a terminal, or another device.

In one embodiment, relevant data such as user information is involved. In the case that the foregoing embodiments of this application are applied to a specific product or technology, a permission or consent of a user is required, and collection, use, and processing of the relevant data need to comply with relevant laws, regulations, and standards of relevant countries and regions.

As shown in FIG. 1b, the classification model training method may include the following specific process.

101: Obtain at least one original sample content and labeled sample content, and obtain a classification model, where the labeled sample content carries an expected content type corresponding thereto, and the classification model includes a feature extraction module and a classification module.

The classification model may be a neural network model. There may be a plurality of types of neural network models. For example, the neural network model may be bidirectional encoder representations from transformers (Bert), a long short-term memory (LSTM), a bi-directional long short-term memory (BiLSTM), or the like. The foregoing examples are not to be construed as limiting the classification model.

Specifically, an original training sample set may be obtained. The original training sample set may include a first quantity of original sample contents, and the original sample contents are unlabeled coarse data. In addition, a labeled training sample set may be obtained according to a target classification task. The labeled training sample set may include a second quantity of labeled sample contents. The labeled sample content may carry tag information. The tag information may be an expected content type of the labeled sample content. The tag information of the labeled sample content may be specifically manually labeled, and is tag information with high accuracy.

The target classification task may be determining whether a content belongs to a field (or type). For example, the target classification task may be determining whether a piece of news is news of an entertainment circle, and the expected content type of the labeled sample content may be a content type of the entertainment circle, or may be a content type of a non-entertainment circle.

The content herein may be information in various content modalities such as a video, an audio, and a text. This is not limited by this embodiment. For example, the original sample content or the labeled sample content may be a long text content, namely, a text content having a text length greater than a preset text length. The preset text content may be set according to an actual situation. The content modalities of the original sample content and the labeled sample content are to be consistent.

In one embodiment, the first quantity is greater than the second quantity, and a difference between the first quantity and the second quantity is greater than a preset quantity. Specifically, the order of magnitudes of the first quantity is greater than an order of magnitudes of the second quantity. Therefore, with respect to the original sample content, the labeled sample content may be referred to as a small sample, where the small sample indicates a small quantity of labeled sample contents.

However, currently, there are some problems facing a classification task in a case of t small quantities of training samples. For example, there is a conflict between a small amount of training data and a large number of to-be-trained parameters. Specifically, a pretraining model based on a huge amount of data is directly transited to transfer learning of a small amount of small sample data, and a data magnitude span is relatively large. Because a data volume does not match the magnitude of a to-be-trained parameter, training convergence may be not sufficiently smooth. It is even difficult to ensure that a training parameter converges effectively, causing a poor model classification effect.

This application may provide a small sample training solution for parameter and data transition learning of a task in the classification field. The solution is a multi-stage progressive training solution, and a training target thereof needs to focus on a classification task in a single field.

Logic of the multi-stage training in this application may be specifically: focusing model training on a small sample classification task step by step. First, a pretraining task solution for classification may be constructed. Next, training data of coarse quality (i.e. the target sample content in the foregoing embodiment) is constructed by using a mining method, and full parameter transfer learning of a model is performed based on the mined training data of coarse quality. Then, model full parameter transfer learning is performed by using manually labeled small sample data (i.e. the labeled sample content in the foregoing embodiment). Finally, local parameter transfer learning is performed by using the manually labeled small sample data. The advantages are: from the perspective of training sample data and a training number of parameters, gradually progressive training convergence is performed, and the training number of parameters has a good matching degree with effective training sample data. Accordingly, the task of pretraining at an early stage is more focused, so that training convergence is better performed on data labeled by a small sample at a late stage.

The transfer learning specifically refers to fine-tuning parameters of a plurality of layers by using a known model network structure and a known model network parameter.

In a specific embodiment, FIG. 1c shows a diagram of a system framework of a classification model training method according to this application. The system framework mainly includes a long text data preprocessing module, a feature extraction chunk, a self-pretraining classification task module, and a small sample classification training task module. The feature extraction chunk may include a basic pretraining model text feature extraction module, a convolutional neural network text feature extraction module, and a feature fusion module. The long text data preprocessing module and the feature extraction chunk may be collectively referred to as a feature extraction module.

An input of this embodiment is corpus data of long texts. In different training operations, the corpus data is represented as constructed coarse surveillance data (i.e. target sample content) and manually labeled surveillance data (i.e. labeled sample content). Core input data of the feature extraction chunking is obtained by using the long text data preprocessing module. The feature extraction chunk includes two submodules. One submodule is the basic pretraining model text feature extraction module that is used as a basic pretraining module and may be based on a transformer structure. The other submodule is the convolutional neural network text feature extraction module of a text convolutional neural network model. The convolutional neural network text feature extraction module plays a supplementary role. Currently, a text length supported by a text input based on the transformer structure is 512, but the length of a long text is usually greater than this value. Therefore, a text feature is extracted by combining the text convolutional neural network model that can support the long text. Then, feature fusion is performed on feature information extracted by the two submodules using a feature fusion module. Finally, different task classification layers are accessed in different training stages, and in a self-pretraining stage, the self-pretraining classification task module is used. In a subsequent small sample classification task stage, the small sample classification training task module is used. An intra-module parameter in a dashed line in FIG. 1c is a to-be-trained parameter.

The text convolutional neural network model is a convolutional neural network model that may be configured for text classification. The text convolutional neural network model is to extract key information (similar to an N-gram model with a plurality of window sizes) from a sentence by using a plurality of convolution kernels of different sizes, so as to better capture local correlation.

In some embodiments, the obtaining a classification model in operation 101 may be implemented by using the following technical solution: obtaining a preset classification task model, and obtaining a positive sample tag and a negative sample tag of the original sample content, where the preset classification task model includes a preset feature extraction module and a preset task module; extracting target feature information of the original sample content by using the preset feature extraction module; calculating, by using the preset task module, a positive similarity between the target feature information and the positive sample tag, and a negative similarity between the target feature information and the negative sample tag; adjusting a parameter of the preset classification task model based on the positive similarity and the negative similarity, to obtain a trained preset classification task model, where the trained preset classification task model includes a trained feature extraction module and task module; and constructing the classification model based on a preset classification module and the trained feature extraction module. According to this embodiment, a feature extraction capability may be learned in the pretraining stage, so that the feature extraction capability learned in the pretraining stage may be subsequently applied to a classification model.

As an example, training of a preset classification task model is the foregoing “constructing a pretraining task solution for classification”, which belongs to a self-pretraining stage. The self-pretraining may specifically refer to pretraining on big data based on the disclosed basic training model. The preset classification task model is specifically a model involved in the self-pretraining stage. The preset classification task model includes a preset feature extraction module and a preset task module. The preset feature extraction module is a feature extraction module in the self-pretraining stage. The preset task module is the self-pretraining classification task module in FIG. 1c.

After training on the preset classification task model is completed, the feature extraction module in the trained classification task model may be used, and a preset classification module is newly added, to construct the classification model. The newly added classification module is the small sample classification training task module in FIG. 1c. A data input end of the newly added classification module is a data output end of the feature extraction module.

In some embodiments, the obtaining at least one positive sample tag and negative sample tag corresponding to the original sample content may be implemented by using the following technical solution: performing keyword extraction on the original sample content, to obtain a positive sample tag of the original sample content under at least one content category; and selecting, for each content category, at least one negative sample tag of the original sample content under the content category from a tag set of the content category, where a tag set of a content category includes content tags under the content category.

As an example, the positive sample tag is a real content tag of the original sample content, and the negative sample tag is a non-real content tag of the original sample content.

As an example, each content category may correspond to one or more content tags. There may be a plurality of content categories, which may be specifically set according to an actual situation. For example, the content category may include categories such as a non-entity, a location name, a person name, an organization name, a product name, a work entity name, time, a literature work, and another entity. The non-entity content category may include content tags such as divorce_emotion, love_emotion, and decoration_household.

In some embodiments, the calculating a positive similarity between the target feature information and the positive sample tag, and a negative similarity between the target feature information and the negative sample tag may be implemented by using the following technical solution: calculating a first vector distance between the target feature information and feature information of the positive sample tag; determining the positive similarity between the target feature information and the positive sample tag according to the first vector distance; calculating a second vector distance between the target feature information and the feature information of the negative sample tag; and determining the negative similarity between the target feature information and the negative sample tag according to the second vector distance. According to this embodiment, a similarity may be quantized by using a vector, thereby improving a learning effect at a pretraining stage.

As an example, the positive similarity is negatively correlated to the first vector distance. A larger first vector distance indicates a smaller positive similarity. On the other hand, a smaller first vector distance indicates a larger positive similarity. The negative similarity is negatively correlated to the second vector distance. A smaller second vector distance indicates a larger negative similarity. On the other hand, a larger second vector distance indicates a smaller negative similarity.

In some embodiments, because the number of parameters of the “basic pretraining model text feature extraction module” is large, an open-source pretrained model may be configured for parameter loading. Based on this, a final classification task is further pretrained, and this operation may be referred to as self-pretraining. For the self-pretraining, a preset classification task model may be constructed. The preset classification task model may include a preset feature extraction module and a preset task module. The preset task module is the self-pretraining classification task module. A training object obtained through self-pretraining not only aims at the “basic pretraining model text feature extraction module” parameter in the preset feature extraction module, but also includes parameters of other modules in the preset feature extraction module and the preset task module.

As an example, a corresponding self-pretraining task may be constructed based on the original sample content (i.e. coarse data). The original sample content may be news text data. Keyword extraction may be performed based on a large amount of news text data, to obtain a plurality of keyword tags corresponding to each article. These extracted keyword tags may be used as positive sample tags corresponding to the article. Specifically, the keyword tags may be classified into nine categories (to be specific, there are nine content categories), which are respectively a non-entity, a location name, a person name, an organization name, a product name, a work entity name, time, a literature work, and another entity. Samples of content tags corresponding to the categories of the keyword tags may be shown in Table 1, and the format is “tag_common category”.

TABLE 1

| | | | | Spring migration_Current | |
|---|---|---|---|---|---|
| Non-entity | Divorce_Emotion | Fortune_Divination | Love_Emotion | politics | Decoration-Household |
| Location name | Henan_Social | Country X_Current | Beijing_Social | Zhengzhou_Social | Nanjing_Social |
| | | politics | | | |
| Person name | Wu_Entertainment | Ronaldo_Sports | Messi_Sports | Cao_History | Liu_History |
| Organization | XX | Rockets_Sports | Xiaomi_Digital | Yonex_Sports | Tesla_Automobile |
| name | University_Education | | | | |
| Product name | MG_Automobile | Trumpchi_Automobile | MG_Automobile | Hongqi_Automobile | Benz_Automobile |
| Work entity name | League of | Honor of Kings_Game | Thunderstorm | XX | Water Margin_Culture |
| | Legends_Game | | wind_Weather | Biography_Entertainment | |
| Time | Qing dynasty_History | Ming dynasty_History | Tang | National Day_Social | Song dynasty_History |
| | | | dynasty_History | | |
| Literature work | Brainpower_Culture | Art of War_History | Economic | Law on Production | Labor Contract |
| | | | regulation_Current | Safety_Current politics | Law_Law |
| | | | politics | | |
| Another entity | Olympics_Sports | Shareholders of Listed | Warning | Command | XX war_History |
| | | company_Finance | signal_Weather | department_Society | |

A quantity Ntag of tag words are selected according to the frequency of occurrence of the words in the news scene. For example, Ntag may be on an order of 100,000. Specifically, a structure of the self-pretraining classification task module is shown in FIG. 1d. The self-pretraining classification task module includes subtask modules of nine content categories. Each subtask module corresponds to a training task. Each content category corresponds to a tag pool (or referred to as a tag set). Quantities of tags in the tag pool of each content category may be respectively denoted as Ntag1, Ntag2, . . . , and Ntag9.

As an example, input data of the self-pretraining classification task module may include target feature information (which may be denoted as doc_feat) of the original sample content outputted by the preset feature extraction module, and a positive sample tag and a negative sample tag of the original sample content outputted by a tag preparing module label_tag under content categories. The positive sample tag may adopt a keyword extraction result of the original sample content, and the negative sample tag may be obtained by sampling from a tag pool of a same type.

FIG. 1e shows a structural diagram of a self-pretraining task, and shows details corresponding to each subtask module. Specifically, each subtask module may obtain the target feature information of the original sample content, and a feature size outfeat_size of the finally outputted target feature information may be outfeat_size=512. In addition, each subtask module may further obtain a positive sample tag and a negative sample tag of the original sample content under the content category corresponding thereto from the tag preparing module.

The tag preparing module includes a text keyword and a sampled negative sample tag. A typical quantity value range of the negative sample tag may be Nneg_tags∈[64, 256]. An obtained content tag may be converted into a corresponding identity (id) form based on the tag preparing module label_tag. Then, vector lookup of a tag is performed on the id by using a tag lookup table tag_lookup_table. A matrix shape of the tag lookup table is [Ntag, outfeat_size], where Ntag refers to the quantity of all tags, i.e. an order of magnitudes of the entire tag lookup table. A vector size of each tag keeps consistency with a feature size outfeat_size of target feature information (denoted as featout). By lookup in the tag lookup table, Nneg_tags+Npos_tags feature vectors having a size of outfeat_size may be obtained. To be specific, feature information pos_emb corresponding to the positive sample tag and feature information corresponding to the negative sample tag neg_emb may be obtained. Nneg_tags indicates the quantity of negative sample tags, and indicates the quantity of positive sample tags.

Based on the positive sample tag and the negative sample tag of the original sample content, and the target feature information, the preset task module may perform loss calculation by using a contrastive loss. A specific calculation process is shown in formula (1):

$$Loss = \frac{1}{2 N} {\sum }_{n = 1}^{N} {YD}^{2} + ( 1 - Y ) {max ( m - D , 0 )}^{2} \qquad ( 1 )$$

where Y represents positiveness or negativeness of a tag, a positive sample tag Y is equal to 1, and a negative sample tag Y is equal to 0. m is a set threshold, and typically m∈[0.1, 0.3]. N is a quantity of positive and negative sample tags. To be specific, N=Nneg_tags+Npos_tags. D represents a vector distance value between a feature vector of each content tag and featout. Specifically, the vector distance may be calculated by using a Euclidean distance.

In some embodiments, the preset task module includes a subtask module corresponding to at least one content category. The positive sample tag includes positive sample tags under content types. The negative sample tag includes negative sample tags under the content types. The calculating, by using the preset task module, a positive similarity between the target feature information and the positive sample tag, and a negative similarity between the target feature information and the negative sample tag may be implemented by using the following technical solution: calculating, for each content category, a positive similarity between a positive sample tag under the content category and the target feature information, and a negative similarity between a negative sample tag under the content category and the target feature information by using a subtask module corresponding to the content category. The adjusting a parameter of the preset classification task model based on the positive similarity and the negative similarity, to obtain a trained classification task model may be implemented by using the following technical solution: determining sub-loss functions corresponding to the content categories based on the positive similarity and the negative similarity; and adjusting the parameter of the preset classification task model according to the sub-loss functions corresponding to the content categories, to obtain the trained classification task model. According to this embodiment, learning of the content categories may be integrated, so that the trained classification task model is compatible with the categories. Therefore, the trained classification task model has compatibility.

In some embodiments, the sub-loss functions corresponding to the content categories may be fused to obtain a total loss function. The fusion mode may be weighted summation or the like. Then, parameters of the preset feature extraction module and the subtask modules in the preset classification task model are adjusted based on the total loss function.

102: Select at least one target sample content from the original sample content based on the expected content type corresponding to the labeled sample content and at least one content tag corresponding to the labeled sample content, and construct an expected content type corresponding to the target sample content.

As an example, at least one original sample content may be selected from the original training sample set as a target sample content needed by the target classification task according to a mapping between the expected content type corresponding to the labeled sample content and at least one content tag corresponding to the labeled sample content. The selected target sample content may be used as coarse data for training the target classification task, and the labeled sample content may be used as precise data for training the target classification task.

Generally speaking, there are two parts of data. One part is data constructed for self-pretraining, namely the original sample content, the content tag thereof, and the like. The other part is a small amount of manually labeled sample data, namely the labeled sample content that may be directly used for training the target classification task.

Specifically, based on a feature extraction module obtained through self-pretraining, a classification module is added according to an actual task. Because parameters of the classification module are randomly initialized, coarse data may be constructed for training. A construction method may be predicting the labeled sample content by using an overall module in a self-training stage, to determine a content tag with a high confidence of the labeled sample content. Then, a mapping is performed between the content tag of the labeled sample content and an expected content type label (i.e. a target task tag) for the target classification task. Then, sample extraction related to a tag is performed based on data constructed for self-pretraining. To be specific, the target sample content related to the content tag of the labeled sample content is extracted from the original sample content, and the extracted content tag of the target sample content is mapped to a new label, namely mapped to a corresponding content type. Therefore, a coarse sample of the target classification task is constructed.

The determining a content tag with a high confidence of the labeled sample content may be specifically predicting the labeled sample content by using an overall model obtained through self-pretraining, to obtain a content prediction result, and determining the content tag with the high confidence based on the content prediction result.

In some embodiments, the content tag may be fine-grained tag information, and a label may be a large-grained tag. For example, an expected content type of a labeled sample content may be that the labeled sample content is news of an entertainment circle, and a content tag of the labeled sample content may be a star in the entertainment circle. For example, the content tag may include “Star Zhao xx”, “Actor Li xx”, and the like.

In some embodiments, the selecting at least one target sample content from the original sample content based on the expected content type corresponding to the labeled sample content and at least one content tag corresponding to the labeled sample content, and constructing an expected content type corresponding to the target sample content in operation 102 may be implemented by using the following technical solution: obtaining a content tag corresponding to the original sample content; establishing a mapping between the expected content type corresponding to the labeled sample content and the content tag corresponding to the labeled sample content; selecting, according to the content tag corresponding to the original sample content, a target sample content associated with the content tag of the labeled sample content from the original sample content; and constructing an expected content type of the target sample content based on the mapping and the expected content type of the labeled sample content. According to this embodiment, an expected content type of a target sample content may be constructed by using an association relationship, to obtain a training sample having a training value, thereby improving a training effect.

As an example, content tag association herein may mean that a similarity between a content tag of an original sample content and a content tag of a labeled sample content is greater than a preset similarity. The preset similarity may be set according to an actual situation. If content tags are associated, the original sample content may be determined as the target sample content.

As an example, an expected content type of the labeled sample content associated with the content tag may be determined as the expected content type of the target sample content.

103: Classify the target sample content by using the classification model, to obtain an content type corresponding to the target sample content.

In some embodiments, the classifying the target sample content by using the classification model, to obtain an content type corresponding to the target sample content in operation 103 may be implemented by using the following technical solution: performing feature extraction on the target sample content by using the feature extraction module, to obtain target feature information of the target sample content; and predicting the content type of the target sample content based on the target feature information by using the classification module.

As an example, an actual probability that the target sample content belongs to each preset content type may be determined by using the classification module based on the target feature information, to determine the content type of the target sample content based on the actual probability. The classification module may specifically be a support vector machine (SVM), a recurrent neural network, a fully-connected deep neural network (DNN), or the like. This is not limited by this embodiment.

As an example, the content type of the target sample content may specifically be an actual probability that the target sample content belongs to each preset content type.

In some embodiments, the target sample content includes at least one content segment, and the content segment includes at least one content unit. The performing feature extraction on the target sample content by using the feature extraction module, to obtain target feature information of the target sample content may be implemented by using the following technical solution: performing key content extraction on the target sample content by using the feature extraction module, to obtain a first content sequence; performing attention encoding processing on content units in the first content sequence, to obtain attention encoding feature information corresponding to the content units in the first content sequence; performing content cropping processing on the target sample content, to obtain a second content sequence; performing sequence feature encoding processing on the second content sequence based on feature information of content units in the second content sequence, to obtain sequence feature information; and fusing the attention encoding feature information and the sequence feature information, to obtain the target feature information of the target sample content. According to this embodiment, attention encoding processing may be performed to obtain target feature information having a representation capability, thereby improving the accuracy of feature extraction.

As an example, if the content modality of the target sample content is text modality, a content segment may be a text sentence in the target sample content, and a content unit may be a phrase or a word. This is not limited in this embodiment.

As an example, a Bert module in the feature extraction module may perform attention encoding processing on content units in the first content sequence, to obtain attention encoding feature information corresponding to the content units in the first content sequence. The Bert is an open-source time sequence model based on a transformer structure. The Bert may be formed by connecting a plurality of layers (which generally may be 12 layers, 24 layers, or the like) of bidirectional transformers. A training process may make full use of context information, so that the model has a stronger expression capability.

Specifically, the Bert model performs a multi-layer attention processing operation on the content units in the first content sequence by using the transformer structure, to obtain attention encoding feature information of the content units in the first content sequence. The attention encoding feature information not only includes semantic information of the content unit, but also includes current context information.

In some embodiments, the feature extraction module may include a long text data preprocessing module and a feature extraction chunk. The long text data preprocessing module may be configured to obtain a first content sequence (or a first identity sequence) and a second content sequence (or a second identity sequence). The feature extraction chunk mainly includes three parts: a basic pretraining model text feature extraction module, a convolutional neural network text feature extraction module, and a feature fusion module. The basic pretraining model text feature extraction module may be configured to obtain attention encoding feature information corresponding to content units in the first content sequence. The convolutional neural network text feature extraction module may be configured to perform sequence feature information of the second content sequence. The feature fusion module may be configured to fuse the attention encoding feature information and the sequence feature information.

FIG. 1f shows a structural diagram of a feature extraction chunk. The basic pretraining model text feature extraction module in the feature extraction chunk may obtain a first identity sequence (length N1) from the long text data preprocessing module, and then convert the first identity sequence into corresponding feature information 1 through a lookup table. Then attention encoding feature information corresponding to content identities in the first identity sequence may be obtained by processing a positional encoding layer and a transformer encoder layer. The textcnn convolutional neural network text feature extraction module in the feature extraction chunk may obtain a second identity sequence (length N2) from the long text data preprocessing module, and then convert the second identity sequence into corresponding feature information 2 through the lookup table. Then sequence feature information may be obtained by processing through a textcnn encoder layer. Finally, the feature fusion module may fuse the attention encoding feature information and the sequence feature information, to obtain and output the target feature information.

As an example, the first identity sequence includes content identities of the content units in the first content sequence, and the second identity sequence includes content identities corresponding to the content units in the second content sequence. The content identity may be number information. The lookup table may include a mapping between a preset content identity and preset feature information.

In some embodiments, the performing key content extraction on the target sample content by using the feature extraction module, to obtain a first content sequence may be implemented by using the following technical solution: determining, for each content segment in the target sample content, segment feature information of the content segment according to the feature information of the content units in the content segment by using the feature extraction module; fusing the segment feature information of the content segments of the target sample content, to obtain global feature information of the target sample content; selecting at least one target content segment from the content segments based on a similarity between the segment feature information of the content segments and the global feature information; and determining the first content sequence according to the target content segment. According to this embodiment, a target content segment that can represent a global content can be obtained.

As an example, feature information lookup may be performed on content units in a content segment, to obtain feature information of the content units in the content segment. The segment feature information of the content segment may be a feature sequence formed by the feature information of the content units in the content segment, or may be obtained by fusing (for example, averaging) the feature information of the content units in the content segment.

As an example, there are a plurality of modes of fusing the segment feature information of the content segments. For example, the fusion mode may be averaging.

As an example, the similarity between the segment feature information of the content segments and the global feature information may be measured by using a vector distance therebetween. A larger vector distance indicates a smaller similarity. On the other hand, a smaller vector distance indicates a larger similarity. In some embodiments, content segments having the similarity greater than a preset similarity may be determined as target content segments. In some other embodiments, the content segments may be ranked according to the similarities, for example, ranked in descending order, to obtain ranked content segments, and first n content segments in the ranked content segments are determined as target content segments.

As an example, the target content segment may be considered as a key content segment in the target sample content. Specifically, when the content modality of the target sample content is text modality, the target content segment may be a key sentence in the target sample content.

In some embodiments, key content extraction on the target sample content may not only include extraction of a key sentence (i.e. the target content segment), but also include extraction of a keyword (i.e. a target content unit). After the target content segment and the target content unit are obtained, the target content segment and the target content unit may be fused to obtain the first content sequence. The fusion mode may be concatenating or the like.

In some embodiments, the performing key content extraction on the target sample content, to obtain a first content sequence may be implemented by using the following technical solution: performing key unit extraction on the target sample content, to select at least one target content unit from content units of the target sample content; performing key segment extraction on the target sample content, to select at least one target content segment from content segments of the target sample content; and fusing the target content unit and the target content segment, to obtain the first content sequence.

As an example, a key unit and a key segment can express a center content of the target sample content, and extracting the key unit and the key segment of the target sample content is important for classification of the target sample content. If the content modality of the target sample content is text, the key unit may be a keyword, and the key segment may be a key sentence.

As an example, for extraction of a key unit, specifically, statistics about frequency information that the content units appear in the target sample content may be collected. In some embodiments, a content unit having frequency information greater than preset frequency information is determined as a key unit, and determined as a target content unit. In some other embodiments, the content units may be ranked according to the magnitude of the frequency information, for example, ranked in descending order according to the magnitude of the frequency information, to obtain ranked content units. First n content units in the ranked content units may be determined as target content units.

In some embodiments, the performing attention encoding processing on content units in the first content sequence, to obtain attention encoding feature information corresponding to the content units in the first content sequence may be implemented by using the following technical solution: performing multi-head attention processing on the content units in the first content sequence, to obtain attention feature information corresponding to the content units; performing residual connection and normalization processing on the attention feature information corresponding to the content units, to obtain processed attention feature information corresponding to the content units; and performing full connection processing on the processed attention feature information corresponding to the content units, to obtain the attention encoding feature information corresponding to the content units in the first content sequence.

As an example, performing multi-head attention processing on the content units in the first content sequence is specifically performing multi-head attention processing on feature information of the content units in the first content sequence.

In some embodiments, the performing full connection processing on the processed attention feature information corresponding to the content units, to obtain the attention encoding feature information corresponding to the content units in the first content sequence may be implemented by using the following technical solution: performing full connection processing on the processed attention feature information corresponding to the content units, to obtain the attention encoding feature information corresponding to the content units in the first content sequence; using the attention encoding feature information as new feature information; and returning to the operation of performing multi-head attention processing on the feature information corresponding to the content units, to obtain attention feature information corresponding to the content units, to obtain attention encoding feature information corresponding to the content units in the first content sequence satisfying a preset condition.

As an example, the preset condition may be set according to an actual situation. For example, the preset condition may be that the quantity of iterations reaches a preset quantity, and the preset quantity may be 12.

In some embodiments, the performing attention encoding processing on content units in the first content sequence, to obtain attention encoding feature information corresponding to the content units in the first content sequence may be implemented by using the following technical solution: determining, according to mask information corresponding to the first content sequence, initial feature information corresponding to the content units in the first content sequence; performing positional encoding on the content units in the first content sequence, to obtain position information corresponding to the content units in the first content sequence; determining, based on the initial feature information and the position information corresponding to the content units, feature information corresponding to the content units; and performing attention encoding processing on the feature information corresponding to the content units, to obtain attention encoding feature information corresponding to the content units in the first content sequence.

As an example, the position information of the content unit may represent a position of the content unit in the first content sequence. For example, the position may be the start or the end.

As an example, if the content modality of the target sample content is text modality, the initial feature information of the content unit may be a word vector of the content unit.

As an example, the feature information corresponding to the content units may be obtained by fusing the initial feature information and the position information corresponding thereto. There are a plurality of modes of fusing the initial feature information and the position information corresponding to the content units. This is not limited in this embodiment. For example, the fusion mode may be concatenating, or may be weighted fusion.

In some embodiments, the determining, according to mask information corresponding to the first content sequence, initial feature information corresponding to the content units in the first content sequence may be implemented by using the following technical solution: performing identity mapping processing on the content units in the first content sequence, to obtain content identities corresponding to the content units in the first content sequence; and performing feature lookup on the content identities in a preset mapping set according to the mask information corresponding to the first content sequence, to obtain initial feature information corresponding to the content identities, where the preset mapping set includes a mapping between preset content identities and preset feature information.

As an example, a value of mask information of each content unit may be 0 or 1, 0 represents that the content unit is invalid, and 1 represents that the content unit is valid. For a content unit in which mask information has a value of 0, feature lookup does not need to be performed, and initial feature information may be regarded as 0.

In some embodiments, the basic pretraining model text feature extraction module may use a parameter of a robustly optimized BERT approach (roberta) pretraining model to initialize an encoder structure parameter of a transformer.

As an example, sub-chunk 1 of the feature extraction chunk in FIG. 1f is a basic pretraining model text feature extraction module (Transformer). Herein, a transformer structure is used. An input is preprocessed text information (denoted as a first identity sequence input idx 1), including two parts: input_ids and input_mask, where input_ids is an id sequence corresponding to a preprocessed text sequence (i.e. the first content sequence in the foregoing embodiment), and a correspondence between an id and a text character is consistent with a configuration during transformer pretraining. input_mask is a sequence indicating valid input_ids, and has the same length as that of input_ids, which is N1. The length N1 may be 512. A value in the input_mask sequence is 0/1, and is configured for indicating whether input_ids at a position corresponding to the sequence is valid.

Specifically, embedding feature vector lookup is first performed on an input first identity sequence input idx 1. Herein, the shape of a lookup table may be [vocab_size, emb_size]=[21168, 768], where vocab_size is the quantity of text characters included in the lookup table, and emb_size is the size of the feature vector. A shape of a result obtained after the lookup may be [N1, emb_size]. Then, a typical positional encoding layer in a transformer is used. Position parameters are added based on original data, and an output result shape after position encoding is [N1, emb_size]. Then, the result is inputted to a transformer encoder module (i.e. a transformer encoder layer). The module includes N layers of repetition submodules. A structure of the submodule is shown in FIG. 1g. Specifically, Nlayer=12. After being processed by the transformer encoder module, a feature vector sequence result (including attention encoding feature information corresponding to the content units in the first content sequence in the foregoing embodiment) having a size of [N1, hidden_layer_size] is finally outputted, and is recorded as

$${H}_{out}^{tran} .$$

The output sequence and the input sequence have the same length, and are both N1. There are N1 vectors having dimensions of hidden_layer_size in the sequences. Typically, hidden_layer_size=768, where an output vector corresponding to a sequence position i is hᵢ, hᵢ∈ [symbol] ^{hidden_layer_size}, i∈[0, N1−1] and hᵢ is attention encoding feature information corresponding to a content unit at the sequence position i in the first content sequence.

The special position i=0 is a CLS layer (a character at the position i=0 in a text sequence at an input stage is a tag [CLS]), and a feature vector corresponding to the CLS layer may be represented as whole semantics.

FIG. 1g shows a structure of each submodule in the transformer encoder module. Each submodule may include processes of multi-head attention, Add&Norm (residual connection and normalization processing), and Feed Forward (feedforward neural network) processing. The Feed-Forward layer may specifically include two fully-connected layers and a non-linear activation function ReLu.

In some embodiments, the performing content cropping processing on the target sample content, to obtain a second content sequence may be implemented by using the following technical solution: performing a forward cropping operation on the target sample content, to obtain a forward content of the target sample content; performing a backward cropping operation on the target sample content, to obtain a backward content of the target sample content; and fusing the forward content and the backward content, to obtain the second content sequence.

For example, it may be considered that information about front and rear parts of the target sample content is important. Therefore, the front part and the rear part in the target sample content may be cropped, and an cropped content length may be set according to an actual situation. The foregoing forward cropping operation is to intercept the front part of the target sample content, and the backward cropping operation is to intercept the rear part of the target sample content.

As an example, there are a plurality of modes of fusing the forward content and the backward content. For example, the fusion mode may be concatenating, to obtain a second content sequence.

In some embodiments, the performing sequence feature encoding processing on the second content sequence based on feature information of content units in the second content sequence, to obtain sequence feature information may be implemented by using the following technical solution: performing identity mapping processing on the content units in the second content sequence, to obtain content identities corresponding to the content units in the second content sequence; performing feature lookup on the content identities in a preset mapping set according to the mask information corresponding to the second content sequence, to obtain feature information corresponding to the content identities, where the preset mapping set includes a mapping between preset content identities and preset feature information; and performing sequence feature encoding on the feature information corresponding to the content identities, to obtain the sequence feature information.

As an example, a value of mask information of each content unit may be 0 or 1, 0 represents that the content unit is invalid, and 1 represents that the content unit is valid. For a content unit in which mask information has a value of 0, feature lookup does not need to be performed, and feature information may be regarded as 0.

In a one embodiment, sub-chunk 2 of the feature extraction chunk in FIG. if is a convolutional neural network text feature extraction module (specifically, a textcnn model), and an input is consistent with an input sequence token id system of sub-chunk 1. Specifically, a length of an input sequence of sub-chunk 2 is N2, and a typical upper limit of N2 is 2000. In the sub-chunk, a lookup table is shared with sub-chunk 1. Through the lookup table, an input sequence may be encoded and outputted as an embedding feature vector sequence, and a feature size of embedding is emb_size. Specifically, the shape of a lookup result embedding feature vector sequence is [N2, emb_size]. Then, sequence feature encoding is performed, by using a textcnn encoder layer, on the embding feature vector sequence outputted in the previous operation. Finally, a mapping layer textcnn output emb module is accessed, so as to output sequence feature information having a shape of [1, hidden_layer_size], where hidden_layer_size is consistent with the embding size of sub-chunk 1, and an output sequence length is 1.

As an example, if the convolutional neural network text feature extraction module does not limit a text length greatly, a textcnn classification network may be replaced with another classification network for this part. A long text feature extraction function can be mainly supported. For example, the network is a hierarchical attention network (HAN), TextRNN, TextRCNN, or Fasttext. Specifically, a network may be selected according to a limitation on memory occupation of a model in an actual application and a requirement on classification accuracy.

In some embodiments, the fusing the attention encoding feature information and the sequence feature information, to obtain the target feature information of the target sample content may be implemented by using the following technical solution: determining target attention encoding feature information in the attention encoding feature information corresponding to the content units in the first content sequence; fusing the target attention encoding feature information and the sequence feature information, to obtain content feature information of the target sample content; and obtaining the target feature information of the target sample content according to a preset mapping matrix and the content feature information.

As an example, the target attention encoding feature information may be the maximum attention encoding feature information corresponding to the content units of the first content sequence.

As an example, there are a plurality of modes of fusing the target attention encoding feature information and the sequence feature information. For example, the fusion mode may be concatenating.

After the content feature information is obtained, the preset mapping matrix and the content feature information may be multiplied, to obtain the target feature information of the target sample content.

In a one embodiment, sub-chunk 3 of the feature extraction chunk in FIG. if is a feature fusion module, and an input is divided into two parts. The first part is a feature vector having a shape of [N1, hidden_layer_size] and generated by sub-chunk 1, and the feature vector is denoted as

$${H}_{out}^{tran} .$$

An output vector corresponding to a sequence position i in

$${H}_{out}^{tran}$$

is hᵢ. The second part is a feature vector having a shape of [1, hidden_layer_size] and generated by sub-chunk 2. There are three parts in a fusion mode. The first part is a CLS layer in [N1, hidden_layer_size] generated in sub-chunk 1, namely embedding when i=0, h₀, which may be denoted as feat0, and a shape of h₀ is [1, hidden_layer_size]. The second part is obtained through calculation by using [N1, hidden_layer_size] generated by sub-chunk 1. The calculation is shown in Formula (2):

$$max ( {H}_{out}^{tran} , axis = 0 ) \qquad ( 2 )$$

where axis=0 may indicate that an operation is performed row by row along a direction of a column in an array, each column in

$${H}_{out}^{tran}$$

may be one hᵢ, and the whole formula takes a maximum value in hᵢ. Through calculation in Formula (2), a vector having a shape of [1, hidden_layer_size] may be obtained, and denoted as feat1.

The third part is a result that is generated by sub-chunk 2 and has a shape of [1, hidden_layer_size], and denoted as feat2.

The three results are fused, for example, vector-concatenated, to obtain a feature feat_{merge} having a shape of [1, 3*hidden_layer_size], which is the content feature information of the target sample content in the foregoing embodiment.

Then, the feature feat_{merge} is multiplied by a parameter-trainable preset mapping matrix: Mproject ∈ [symbol] ^{3*hidden_layer_size×outfeat_size}, to obtain a final output feature doc_feat (i.e. the target feature information of the target sample content), as shown in Formula (3):

$$doc\_feat = {feat}_{merge} \times {M}_{project} \qquad ( 3 )$$

A shape of doc_feat is [1, outfeat_size], where outfeat_size is a set finally-outputted feature size, and typically, outfeat_size=512.

A system framework diagram of a long text data preprocessing module is shown in FIG. 1h. The long text data preprocessing module is an input preprocessing module, mainly including two parts, which respectively generate two preprocessing results as input data in the feature extraction chunk in FIG. 1f. The two parts are respectively a first identity sequence (denoted as input idx 1) and a second identity sequence (denoted as input idx 2).

Specifically, the long text data preprocessing module is shown in FIG. 1h. Two parts are formed by chunk 1 and chunk 2. An output of chunk 1 is input idx 1, an output of chunk 2 is input idx 2, and sequence lengths thereof are respectively N1 and N2. Typically, N1=512, N2=2000.

In chunk 1, input text (i.e. a sample content) is respectively subjected to keyword extraction and key sentence extraction by using two modules. The functions of the two modules are to extract main feature information of a long text into a sequence having a length of N1 as much as possible. The keyword extraction may be obtained by using a textRank (text ranking) algorithm, and the quantity of extracted words may be N_{keyword}. Typically, N_{keyword}=20, so as to obtain text text_{keyword} formed by keywords.

The key sentence extraction is divided into three stages as follows:

1) First, a text is divided. To be specific, a long text is divided into a plurality of sentences, which may be represented as D0=c [Sent₁, Sent₂, . . . , Sentₙ], where D0 represents a sample content.

Next, word segmentation is performed on each sentence, to obtain a data form that there are a plurality of sentences and each sentence has a plurality of words. Assuming that n sentences are obtained, a form of the result is as follows:

$$D 1 = [ [ {w}_{11} , {w}_{12} , … {w}_{{1}_{{m}_{1}}} ] , [ {w}_{21} , {w}_{22} , … {w}_{{1}_{{m}_{2}}} ] , … [ {w}_{n 1} , {w}_{n 2} , … {w}_{{1}_{{m}_{n}}} ] ]$$

where m₁, m₂, . . . mₙ represents the quantity of words of each sentence, and not necessarily equal. D1 represents a sample content.

2) Word vector lookup is performed on each word by using a preset word vector library. The preset word vector library may be a dense high-dimensional floating point vector of 200 dimensions corresponding to a Chinese word. Data D2 obtained after vector lookup is performed is:

$$D 2 = [ [ {v}_{11} , {v}_{12} , … {v}_{{1}_{{k}_{1}}} ] , [ {v}_{21} , {v}_{22} , … {v}_{{1}_{{k}_{2}}} ] , … [ {v}_{j 1} , {v}_{j 2} , … {v}_{{1}_{{k}_{j}}} ] ] ,$$

where k₁, k₂, . . . , kⱼ represents the quantity of vector lookup results of each sentence, and not necessarily equal to each other. In addition, k and m of a corresponding sentence are not necessarily equal to each other. If the word vector library is not hit at the lookup stage, the word may be discarded. In addition, the sentence quantities j and n are not necessarily equal. If all words in a sentence do not hit the word vector library, the sentence is also discarded, but a correspondence between j and n needs to be recorded.

Next, vector averaging is performed on the word vectors in each sentence, to obtain a plurality of sentence vectors,

$$D 3 = normal ( avg ( D 2 , axis = 1 ) ) = [ v 1 , v 2 , … , vj ]$$

where normal is a normalization operation of vectors, so that a modulus of each vector is |vᵢ|²=1, and v₁, v₂, . . . , vⱼ is segment feature information corresponding to each sentence.

3) Similarity calculation and ranking are performed.

First, an overall vector (i.e. the global feature information in the foregoing embodiment) of a text is calculated, as shown in Formula (4):

$${D}_{doc} = normal ( avg ( D 3 , axis = 0 ) ) = {v}_{doc} \qquad ( 4 )$$

where |v_{doc}|²=1, and D_{doc} represents the global feature information.

Then similarity calculation is performed on each sentence vector (i.e. the segment feature information) and the text overall vector, and cosin similarity may be used for calculation, to obtain a similarity score of each sentence vector, as shown in Formula (5):

$$Score = D 3 \times {v}_{doc}^{T} = {[ {s}_{1} , {s}_{2} , … , {s}_{j} ]}^{T} \qquad ( 5 )$$

where sᵢ is a similar result floating-point scalar value, and represents the similarity score.

The result scores are ranked, the corresponding original sentences are ranked according to a ranking order, and first N_{keysent}. sentences are extracted as key sentences, where N_{keysent} may satisfy a preset quantity condition, so as to obtain text_{keysent} based on the selected key sentences.

The preset quantity condition may be shown in Formula (6):

$${\sum }_{i = 0}^{{N}_{keysent}} len ( {Sent}_{i} ) < N 1 - {\sum }_{i = 0}^{{N}_{keyword}} len ( {Keyword}_{i} ) < {\sum }_{i = 0}^{{N}_{keysent} + 1} len ( {Sent}_{i} ) \qquad ( 6 )$$

After being processed by the keyword extraction module and the key sentence extraction module, the content needs to be processed by a concatenating and combining module, and a concatenating form of the concatenating and combining module may be: text1=<T>title<K>text_{keyword}<S>text_{keysent}, where a title, a target content unit text_{keyword}, and a target content segment text_{keysent} are separated by using separators <T> <K> <S>, and text1 is the first content sequence in the foregoing embodiment.

In chunk 2 in FIG. 1h, if N2 is large, an cropping operation may be performed on the input text, and the input text is processed by a text cropping module. Specifically, when the text length of the input sample content is less than N2, no cropping operation is performed, and the input sample content is directly transparently transmitted to the module for output. When the text length of the input sample content is greater than N2, the cropping operation needs to be performed. It may be considered that the front and the back of an article have important information. Therefore, bidirectional cropping may be performed at this stage. To be specific, some texts are cropped backward from the start of the text, and some texts are cropped backward from the end of the text. In some embodiments, a forward proportion may be 0.7, and a backward proportion is 1−0.7=0.3. To be specific, a text cropped in the forward direction may be represented as textₚ=doc[: int (N2*0.7)], and a text cropped in the backward direction may be represented as text_{b}=doc[−int(N2*0.3):]. The two texts are concatenated to obtain a text preprocessing result text2=textₚ+text_{b} of chunk 2,
where text2 is the second content sequence in the foregoing embodiment.

In FIG. 1h, after text preprocessing is completed in chunks 1 and 2, the text may be processed by a token conversion module (i.e. an identity conversion module). The token conversion module performs a tokenization operation on the text, namely performs character-level id mapping on the text, to obtain an id sequence of the input text, and obtain a mask sequence. The mask sequence is a 0/1 sequence for identifying a position of a valid character text. The token conversion module processes the first content sequence and the second content sequence, to obtain two results: an input idx 1 and an input idx 2, and use the two results as inputs of the feature extraction chunk.

104: Adjust parameters of the feature extraction module and the classification module in the classification model based on the content type and the expected content type corresponding to the target sample content, to obtain an adjusted classification model.

As an example, adjustment of parameters of the feature extraction module and the classification module may include adjustment of quantities of neurons in the feature extraction module and the classification module, adjustment of connection weights and biases between the neurons, and the like.

As an example, the content type corresponding to the target sample content may be an actual probability that the target sample content is in each preset content type, and the expected content type corresponding to the target sample content may be an expected probability that the target sample content is in each preset content type.

In some embodiments, the training process includes first calculating a loss function between the actual probability and the expected probability, then adjusting parameters of the feature extraction module and the classification module by using a back propagation algorithm, and optimizing the parameters of the feature extraction module and the classification module based on the loss function, so that a loss value between the actual probability and the expected probability is less than a preset loss value, to obtain the adjusted classification model. The preset loss value may be set according to specific scenarios.

In some embodiments, the target sample content may be labeled by using a small amount of labeled sample content, to construct coarse data for model training, thereby ensuring model training validity in the case of a small amount of labeled information.

105: Classify the labeled sample content by using the adjusted classification model, to obtain an content type of the labeled sample content.

As an example, after the model is trained by using coarse data, labeled data having high accuracy, i.e. the labeled sample content, may be used to train the model.

In some embodiments, the classifying the labeled sample content by using the adjusted classification model, to obtain an content type of the labeled sample content in operation 105 may be implemented by using the following technical solution: performing feature extraction on the labeled sample content by using a feature extraction module in the adjusted classification model, to obtain target feature information of the labeled sample content; and predicting, by using a classification module in the adjusted classification model, an content type of the labeled sample content based on the target feature information of the labeled sample content.

As an example, after the content type of the labeled sample content is obtained through prediction, parameter adjustment may be performed on only the classification module based on the content type and the expected content type of the labeled sample content.

In some embodiments, before performing parameter adjustment only on the classification module based on the labeled sample content, parameters of the feature extraction module and the classification module may be adjusted first by using the labeled sample content, and finally, the parameter of the classification module is further adjusted by using the remaining labeled sample content, to obtain a final target classification model.

In some embodiments, before the classifying the labeled sample content by using the adjusted classification model, to obtain an content type of the labeled sample content, the following technical solution may be further executed: classifying the labeled sample content by using the adjusted classification model, to obtain an content type of the labeled sample content; and adjusting parameters of a feature extraction module and a classification module in the adjusted classification model according to the content type, to obtain a re-adjusted classification model.

As an example, overall training is performed on the model by using the labeled sample content. In the training process, hybrid training may be performed on previous coarse data (i.e. the target sample content) and manually labeled data (i.e. the labeled sample content) on a data level. In the training process, the coarse data is proportionally attenuated, and finally reduced to 0. For example, an initial proportion may be that the proportion of the coarse data is 50%, and the proportion of the coarse data is reduced by 10% after each epoch stage.

In some embodiments, before the classifying the labeled sample content by using the adjusted classification model, to obtain an content type of the labeled sample content in operation 103, the following technical solution may be further executed: selecting samples from the target sample content and the labeled sample content, and constructing at least one hybrid training sample set based on the selected samples, where proportions of the target sample content and the labeled sample content in each hybrid training sample set are different; determining a training order of the hybrid training sample sets based on the proportions corresponding to the hybrid training sample sets; classifying the sample content in each hybrid training sample set based on the training order by using the adjusted classification model, to obtain an content type of the sample content in each hybrid training sample set; and re-adjusting parameters of a feature extraction module and a classification module in the adjusted classification model according to the content type, to obtain a re-adjusted classification model.

As an example, sample selection is performed in the target sample content and the labeled sample content. To be specific, sample selection is performed in the coarse training sample set and the labeled training sample set. As an example, a larger proportion of the target sample content in the hybrid training sample set indicates a higher training order of the hybrid training sample set. On the other hand, a smaller proportion of the target sample content in the hybrid training sample set indicates a lower training order of the hybrid training sample set.

In some embodiments, the classifying the sample content in each hybrid training sample set based on the training order by using the adjusted classification model, to obtain an content type of the sample content in each hybrid training sample set may be implemented by using the following technical solution: determining, according to the training order, a target hybrid training sample set currently configured for training; and classifying a sample content in the target hybrid training sample set by using the adjusted classification model, to obtain an content type of the sample content in the target hybrid training sample set. The re-adjusting parameters of a feature extraction module and a classification module in the adjusted classification model according to the content type, to obtain a re-adjusted classification model may be implemented by using the following technical solution: re-adjusting the parameters of the feature extraction module and the classification module in the adjusted classification model according to the content type and an expected content type of the sample content in the target hybrid training sample set; and selecting a new target hybrid training sample set from the hybrid training sample sets according to the training order, and returning to the operation of classifying a sample content in the target hybrid training sample set by using the adjusted classification model, to obtain an content type of the sample content in the target hybrid training sample set, to obtain a re-adjusted classification model.

In some embodiments, the re-adjusting the parameters of the feature extraction module and the classification module in the adjusted classification model according to the content type and an expected content type of the sample content in the target hybrid training sample set may be implemented by using the following technical solution: determining, for each sample content in the target hybrid training sample set, a sub-loss function corresponding to the sample content based on the content type and the expected content type of the sample content; fusing sub-loss functions corresponding to the sample contents in the target hybrid training sample set (there are a plurality of modes of fusing the sub-loss functions, for example, weighted fusion), to determine a total loss function corresponding to the target hybrid training sample set; and adjusting, based on the total loss function, parameters in the feature extraction module and the classification module in the adjusted classification model.

106: Update a parameter of a classification module in the adjusted classification model according to the content type and the expected content type of the labeled sample content, to obtain a target classification model, where the target classification model is configured for classifying a content to be processed, to obtain a content type of the content to be processed.

As an example, the classification module is a small sample classification task module. The small sample classification task module may be used at a stage of actual classification of a service requirement, to perform classification training on a small sample of service data. The module is mainly a module using a small number of parameters. FIG. 1i shows a structural diagram of a small sample classification task module.

As an example, after the target feature information of the labeled sample content is extracted by using the feature extraction module, the target feature information may be inputted to the classification module. The classification module may be embodied as a “classification function” module in FIG. 1i. An actual probability that the labeled sample content belongs to each preset content type may be predicted by using the “classification function” module. After the actual probability is obtained, the loss value may be calculated by using a cross entropy loss function, as shown in Formula (7):

$$Loss = - \frac{1}{n} {\sum }_{i = 1}^{n} ( {y}_{i} log ( {p}_{i} ) + ( 1 - {y}_{i} ) log ( {p}_{i} ) ) \qquad ( 7 )$$

where yi represents a label (i.e. the expected content type) of sample content i, a positive sample content is 1, and a negative sample content is 0. pi represents an actual probability that sample content i is predicted to be positive. n represents the quantity of categories.

A calculation mode of pi may be a sigmoid function. To be specific, a calculation process corresponding to the “classification function” module in FIG. 1i may be shown in Formula (8):

$${p}_{i} = \frac{1}{1 - e \text{?}} \qquad ( 8 )$$

$$\text{?} \text{indicates text missing or illegible when filed}$$

where xi is a doc_feat vector, and θi is a to-be-trained parameter of a classification function corresponding to each category.

Specifically, the logic of multi-stage training of a small sample classification task training policy provided by the classification model training method of this application is to gradually focus model training on a small sample classification task. First, a self-pretraining task solution for classification is constructed. Then, full parameter transfer learning of training data of coarse quality is constructed by using a mining method. And then, full parameter transfer learning is performed by using manually labeled small sample data. Finally, local parameter transfer learning is performed by using the manually labeled small sample data. Specific methods are as follows:

S1: At a self-pretraining stage, FIG. 1j shows a structural diagram of a model corresponding to a self-pretraining stage. A specific process of self-pretraining is described in the foregoing embodiment, and details are not described herein again. After the self-pretraining is completed, a structure and a parameter in the dashed box, specifically, parameters of the feature extraction module, are used as a model result of the self-pretraining.

S2: FIG. 1k shows a coarse data training stage. Based on operation S1, a feature extraction module (a gray box part) of a self-pretraining module is obtained, and a classification module (a black box with a bold line) is added according to an actual task. Because the parameter of the classification module is randomly initialized, this part may construct coarse data for training. For a method for constructing a coarse sample of a target task, refer to descriptions in the foregoing embodiment, and details are not described herein again.

Then, the entire model of the structure in FIG. 1k may be trained based on the coarse sample. A training parameter range is a parameter of the structure in the dashed line.

S3: In the previous operation S2, the parameter of the classification module in the model is trained and converged by using the coarse data, and then, labeled data is used for training. In this operation, hybrid training may be performed on previous coarse data and manually labeled data on a data level. In the training process, the coarse data is proportionally attenuated in the training process, and finally reduced to 0. For example, an initial proportion may be that the proportion of the coarse data is 50%, and reduced by 10% after each epoch. The parameter training range is a range included in the dashed box in FIG. 1k.

S4: In the previous operation S3, only labeled data remains at the later stage of training, the data volume is relatively small, and a number of parameters included in the dashed box is huge. In this operation, the parameters in the gray box in FIG. 1k are frozen and set to a non-trainable state. Only parameters in the black boxes with bold lines are trained, and the number of parameters is small. Final training is performed by using the labeled data, to obtain a final classification model of a target task.

According to the classification model training method provided in this application, a good effect can be obtained on long text classification based on a small quantity of labeled samples.

Specifically, this application provides a neural network text feature extraction framework, which can well support feature extraction and classification task training of a long text. Based on a transformer model and with reference to textcnn, a long text characteristic of textcnn is used as a supplement to the transformer, so as to optimize a problem that the transformer does not support enough long text sequences, and improve a classification and understanding capability of the model for the long text.

This application further provides a pretraining solution for a classification task. Pretraining is performed by using fine-grained classification, so that the classification task can be well transferred to another classification task. In addition, the pretraining task covers a plurality of types of classification systems, so that a pretraining model can better deal with different actual classification tasks. In addition, a textcnn initialization parameter part in a model structure is further pretrained, and the parameter is learned and adjusted on the classification task, and can quickly converge on new task data.

Specifically, after feature extraction is performed on the features extracted by the transformer model and a text classification model such as textcnn, text features are obtained by combination. Self-pretraining is performed based on the feature. The pretraining task is mainly for a classification task. A task architecture of 9 types of tags is used, and common fine-grained tag words of a relatively large scale are pretrained in combination with a large amount of easily obtained news data, to obtain a pretraining model of this application.

In addition, this application further provides a training solution of data staged training and parameter staged training. First, a large amount of unlabeled mining-based coarse surveillance data is used, and after an open-source parameter is loaded, further self-pretraining is performed, and a large amount of data training is performed on a global parameter (including a pretraining parameter and a task module parameter). Then, a classification module is newly added, and a coarse target task is constructed based on the labeled data and the pretraining model for training. And then, normal global parameter finetuning training is performed by using a small amount of labeled data. Finally, the pretraining parameter is frozen (a large number of parameters), and only a small quantity of newly added classification layer parameters are trained, to correspondingly debug a small quantity of parameters by matching small data. According to a multi-stage progressive learning method, a target classification task is gradually converged and can be finally relatively converged on training data of a small sample, thereby achieving good available accuracy and recall.

This application resolves a problem of complex procedures of conventional data labeling, and changes original procedures (standard extraction on a demand side, outsource bidding, labeling training, data labeling, delivery review, data labeling completed for multiple rounds of iteration, and algorithm learning) to labeling, on the demand side, a small quantity of samples according to a requirement of the demand side and algorithm learning. The original procedures usually have a long period, many participants, high costs, and low efficiency. This application can greatly improve efficiency and reduce costs.

This application can be mainly applied to a system for automatically classifying long texts such as news and self-media information, and can assist in interest guidance for content distribution, construction and maintenance of an interest content pool of various categories, material supplementation assisting in content production, and the like, to improve experience of users during reading a long text content. In an application app of an information flow, a corresponding classification system is constructed for text or interest tags are added to well describe an interest content of a user. With regard to the current problem of cost of data labeling and a problem of communication efficiency in a labeling process, in this application, a corresponding model can be constructed quickly with a small labeling amount, and a good effect can be achieved.

It may be learned from the foregoing that in this embodiment, at least one original sample content and labeled sample content may be obtained, and a classification model may be obtained, where the labeled sample content carries an expected content type corresponding thereto, and the classification model includes a feature extraction module and a classification module. At least one target sample content is selected from the original sample content based on the expected content type corresponding to the labeled sample content and at least one content tag corresponding to the labeled sample content, and an expected content type corresponding to the target sample content is constructed. The target sample content is classified by using the classification model, to obtain an content type corresponding to the target sample content. Parameters of the feature extraction module and the classification module in the classification model are adjusted based on the content type and the expected content type corresponding to the target sample content, to obtain an adjusted classification model. The labeled sample content is classified by using the adjusted classification model, to obtain an content type of the labeled sample content. A parameter of a classification module in the adjusted classification model is updated according to the content type and the expected content type of the labeled sample content, to obtain a target classification model, where the target classification model is configured for classifying a content to be processed, to obtain a content type of the content to be processed. In this application, a target sample content for training a target task may be mined by using a labeled sample content, so that the quantity of training samples is greatly increased. Accordingly, efficiency of obtaining a training sample can be improved, and not all training samples need to be labeled, thereby greatly improving training efficiency and reducing training costs. In addition, in this application, multi-stage training and learning may be performed. First, an overall parameter of a model is adjusted based on the mined target sample content. Then, a parameter of a classification module is adjusted by using the labeled sample content. Accordingly, a multi-stage progressive learning method enables the model to converge well, so that classification accuracy of a target classification model obtained through training is higher.

According to the method described in the foregoing embodiment, the following further provides detailed descriptions by using an example in which the classification model training apparatus is specifically integrated in a server.

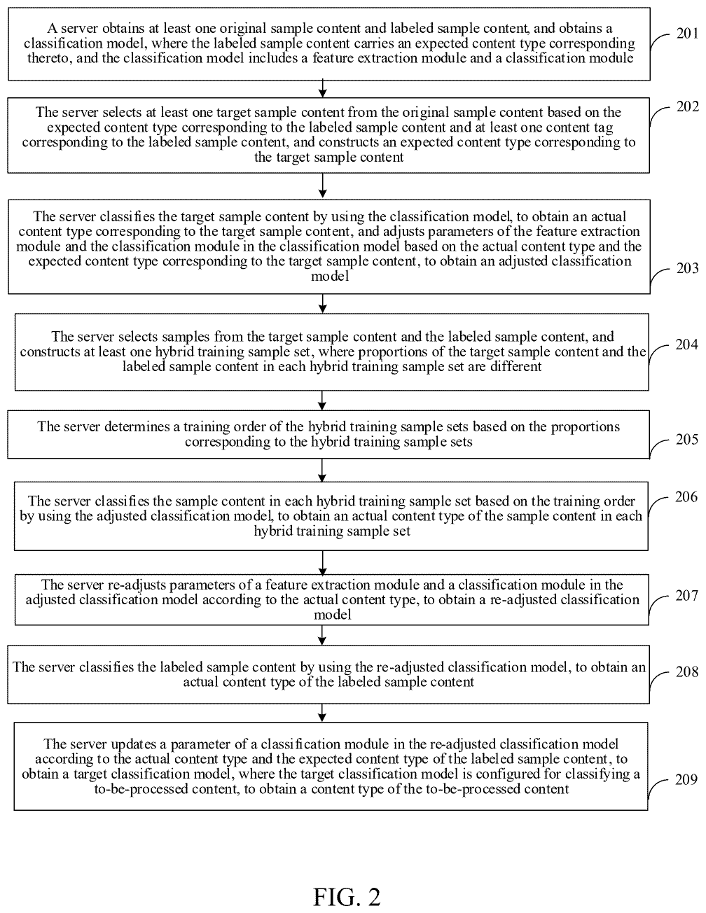

An embodiment of this application provides a classification model training method. As shown in FIG. 2, the classification model training method may include the following specific process.

201: A server obtains at least one original sample content and labeled sample content, and obtains a classification model, where the labeled sample content carries an expected content type corresponding thereto, and the classification model includes a feature extraction module and a classification module.

As an example, an original training sample set may be obtained. The original training sample set may include a first quantity of original sample contents, and the original sample contents are unlabeled coarse data. In addition, a labeled training sample set may be obtained according to a target classification task. The labeled training sample set may include a second quantity of labeled sample contents. The labeled sample content may carry tag information. The tag information may be an expected content type of the labeled sample content. The tag information of the labeled sample content may be specifically manually labeled, and is tag information with high accuracy.

As an example, the first quantity is greater than the second quantity, and the difference between the first quantity and the second quantity is greater than a preset quantity. Specifically, the order of magnitudes of the first quantity is greater than an order of magnitudes of the second quantity. Therefore, with respect to the original sample content, the labeled sample content may be referred to as a small sample, where the small sample indicates a small quantity of labeled sample contents.

In some embodiments, the obtaining a classification model in operation 201 may be implemented by using the following technical solution: obtaining a preset classification task model, and obtaining a positive sample tag and a negative sample tag of the original sample content, where the preset classification task model includes a preset feature extraction module and a preset task module; extracting target feature information of the original sample content by using the preset feature extraction module; calculating, by using the preset task module, a positive similarity between the target feature information and the positive sample tag, and a negative similarity between the target feature information and the negative sample tag; adjusting a parameter of the preset classification task model based on the positive similarity and the negative similarity, to obtain a trained classification task model, where the classification task model includes a trained feature extraction module and task module; and constructing the classification model based on a preset classification module and the trained feature extraction module.

As an example, training of a preset classification task model belongs to a self-pretraining stage. The self-pretraining may specifically refer to pretraining on big data based on the disclosed basic training model. The preset classification task model is specifically a model involved in the self-pretraining stage. The preset classification task model includes a preset feature extraction module and a preset task module. The preset feature extraction module is a feature extraction module in the self-pretraining stage. The preset task module is the self-pretraining classification task module.

After training on the preset classification task model is completed, the feature extraction module in the trained classification task model may be used, and a preset classification module is newly added, to construct the classification model. Specifically, a data input end of the newly added classification module is a data output end of the feature extraction module.

As an example, each content category may correspond to one or more content tags. There may be a plurality of content categories, which may be specifically set according to an actual situation. For example, the content category may include categories such as a non-entity, a location name, a person name, an organization name, a product name, a work entity name, time, a literature work, and another entity. The non-entity content category may include content tags such as divorce_emotion, love_emotion, and decoration_household.

In some embodiments, the preset task module includes a subtask module corresponding to at least one content category. The positive sample tag includes positive sample tags under content types. The negative sample tag includes negative sample tags under the content types. The calculating, by using the preset task module, a positive similarity between the target feature information and the positive sample tag, and a negative similarity between the target feature information and the negative sample tag may be implemented by using the following technical solution: calculating, for each content category, a positive similarity between a positive sample tag under the content category and the target feature information, and a negative similarity between a negative sample tag under the content category and the target feature information by using a subtask module corresponding to the content category. The adjusting a parameter of the preset classification task model based on the positive similarity and the negative similarity, to obtain a trained classification task model may be implemented by using the following technical solution: determining sub-loss functions corresponding to the content categories based on the positive similarity and the negative similarity; and adjusting the parameter of the preset classification task model according to the sub-loss functions corresponding to the content categories, to obtain the trained classification task model.

In some embodiments, the sub-loss functions corresponding to the content categories may be fused to obtain a total loss function. The fusion mode may be weighted summation or the like. Then, parameters of the preset feature extraction module and the subtask modules in the preset classification task model are adjusted based on the total loss function.

202: The server selects at least one target sample content from the original sample content based on the expected content type corresponding to the labeled sample content and at least one content tag corresponding to the labeled sample content, and constructs an expected content type corresponding to the target sample content.

As an example, at least one original sample content may be selected from the original training sample set as a target sample content needed by the target classification task according to a mapping between the expected content type corresponding to the labeled sample content and at least one content tag corresponding to the labeled sample content. The selected target sample content may be used as coarse data for training the target classification task, and the labeled sample content may be used as precise data for training the target classification task.

In some embodiments, the selecting at least one target sample content from the original sample content based on the expected content type corresponding to the labeled sample content and at least one content tag corresponding to the labeled sample content, and constructing an expected content type corresponding to the target sample content in operation 202 may be implemented by using the following technical solution: obtaining a content tag corresponding to the labeled sample content and a content tag corresponding to the original sample content; establishing a mapping between the expected content type corresponding to the labeled sample content and the content tag corresponding to the labeled sample content; selecting, according to the content tag corresponding to the original sample content, a target sample content associated with the content tag of the labeled sample content from the original sample content; and constructing an expected content type of the target sample content based on the mapping and the expected content type of the labeled sample content.

As an example, content tag association herein may mean that a similarity between a content tag of an original sample content and a content tag of a labeled sample content is greater than a preset similarity. The preset similarity may be set according to specific scenarios. If content tags are associated, the original sample content may be determined as the target sample content.

As an example, an expected content type of the labeled sample content associated with the content tag may be determined as the expected content type of the target sample content.

203: The server classifies the target sample content by using the classification model, to obtain an content type corresponding to the target sample content, and adjusts parameters of the feature extraction module and the classification module in the classification model based on the content type and the expected content type corresponding to the target sample content, to obtain an adjusted classification model.

In some embodiments, the classifying the target sample content by using the classification model, to obtain an content type corresponding to the target sample content in operation 203 may be implemented by using the following technical solution: performing feature extraction on the target sample content by using the feature extraction module, to obtain target feature information of the target sample content; and predicting the content type of the target sample content based on the target feature information by using the classification module.

In some embodiments, the target sample content includes at least one content segment, and the content segment includes at least one content unit. The performing feature extraction on the target sample content by using the feature extraction module, to obtain target feature information of the target sample content may be implemented by using the following technical solution: performing key content extraction on the target sample content by using the feature extraction module, to obtain a first content sequence; performing attention encoding processing on content units in the first content sequence, to obtain attention encoding feature information corresponding to the content units in the first content sequence; performing content cropping processing on the target sample content, to obtain a second content sequence; performing sequence feature encoding processing on the second content sequence based on feature information of content units in the second content sequence, to obtain sequence feature information; and fusing the attention encoding feature information and the sequence feature information, to obtain the target feature information of the target sample content.

In some embodiments, the performing key content extraction on the target sample content by using the feature extraction module, to obtain a first content sequence may be implemented by using the following technical solution: determining, for each content segment in the target sample content, segment feature information of the content segment according to the feature information of the content units in the content segment by using the feature extraction module; fusing the segment feature information of the content segments of the target sample content, to obtain global feature information of the target sample content; selecting at least one target content segment from the content segments based on a similarity between the segment feature information of the content segments and the global feature information; and determining the first content sequence according to the target content segment.

As an example, the target content segment may be considered as a key content segment in the target sample content. Specifically, when the content modality of the target sample content is text modality, the target content segment may be a key sentence in the target sample content.

In some embodiments, key content extraction on the target sample content may not only include extraction of a key sentence (i.e. the target content segment), but also include extraction of a keyword (i.e. a target content unit). After the target content segment and the target content unit are obtained, the target content segment and the target content unit may be fused to obtain the first content sequence. The fusion mode may be concatenating or the like.

In some embodiments, the performing attention encoding processing on content units in the first content sequence, to obtain attention encoding feature information corresponding to the content units in the first content sequence may be implemented by using the following technical solution: performing multi-head attention processing on the content units in the first content sequence, to obtain attention feature information corresponding to the content units; performing residual connection and normalization processing on the attention feature information corresponding to the content units, to obtain processed attention feature information corresponding to the content units; and performing full connection processing on the processed attention feature information corresponding to the content units, to obtain the attention encoding feature information corresponding to the content units in the first content sequence.

In some embodiments, the performing content cropping processing on the target sample content, to obtain a second content sequence may be implemented by using the following technical solution: performing a forward cropping operation on the target sample content, to obtain a forward content of the target sample content; performing a backward cropping operation on the target sample content, to obtain a backward content of the target sample content; and fusing the forward content and the backward content, to obtain the second content sequence.

For example, it may be considered that information about front and rear parts of the target sample content is important. Therefore, the front part and the rear part in the target sample content may be cropped, and an cropped content length may be set according to an actual situation. The foregoing forward cropping operation is to intercept the front part of the target sample content, and the backward cropping operation is to intercept the rear part of the target sample content.

As an example, there are a plurality of modes of fusing the forward content and the backward content. For example, the fusion mode may be concatenating, to obtain a second content sequence.

204: The server selects samples from the target sample content and the labeled sample content, and constructs at least one hybrid training sample set, where proportions of the target sample content and the labeled sample content in each hybrid training sample set are different.

205: The server determines a training order of the hybrid training sample sets based on the proportions corresponding to the hybrid training sample sets.

As an example, a larger proportion of the target sample content in the hybrid training sample set indicates a higher training order of the hybrid training sample set. On the other hand, a smaller proportion of the target sample content in the hybrid training sample set indicates a lower training order of the hybrid training sample set.

206: The server classifies the sample content in each hybrid training sample set based on the training order by using the adjusted classification model, to obtain an content type of the sample content in each hybrid training sample set.

207: The server re-adjusts parameters of a feature extraction module and a classification module in the adjusted classification model according to the content type, to obtain a re-adjusted classification model.

In some embodiments, the classifying the sample content in each hybrid training sample set based on the training order by using the adjusted classification model, to obtain an content type of the sample content in each hybrid training sample set in operation 206 may be implemented by using the following technical solution: determining, according to the training order, a target hybrid training sample set currently configured for training; and classifying a sample content in the target hybrid training sample set by using the adjusted classification model, to obtain an content type of the sample content in the target hybrid training sample set. The re-adjusting parameters of a feature extraction module and a classification module in the adjusted classification model according to the content type, to obtain a re-adjusted classification model in operation 207 may be implemented by using the following technical solution: re-adjusting the parameters of the feature extraction module and the classification module in the adjusted classification model according to the content type and an expected content type of the sample content in the target hybrid training sample set; and selecting a new target hybrid training sample set from the hybrid training sample sets according to the training order, and returning to the operation of classifying a sample content in the target hybrid training sample set by using the adjusted classification model, to obtain an content type of the sample content in the target hybrid training sample set, to obtain a re-adjusted classification model.

In some embodiments, the re-adjusting the parameters of the feature extraction module and the classification module in the adjusted classification model according to the content type and an expected content type of the sample content in the target hybrid training sample set may be implemented by using the following technical solution: determining, for each sample content in the target hybrid training sample set, a sub-loss function corresponding to the sample content based on the content type and the expected content type of the sample content; fusing the sub-loss functions corresponding to the sample contents in the target hybrid training sample set, to determine a total loss function corresponding to the target hybrid training sample set; and adjusting, based on the total loss function, parameters in the feature extraction module and the classification module in the adjusted classification model.

The sub-loss functions may be fused in a plurality of modes, for example, weighted fusion.

208: The server classifies the labeled sample content by using the re-adjusted classification model, to obtain an content type of the labeled sample content.

209: The server updates a parameter of a classification module in the re-adjusted classification model according to the content type and the expected content type of the labeled sample content, to obtain a target classification model, where the target classification model is configured for classifying a content to be processed, to obtain a content type of the content to be processed.

This application further provides a pretraining solution for a classification task. Pretraining is performed by using fine-grained classification, so that the classification task can be well transferred to another classification task. In addition, the pretraining task covers a plurality of types of classification systems, so that a pretraining model can better deal with different actual classification tasks. In addition, a textcnn initialization parameter part in a model structure is further pretrained, and the parameter is learned and adjusted on the classification task, and can quickly converge on new task data.

Specifically, after feature extraction is performed on the features extracted by the transformer model and a text classification model such as textcnn, text features are obtained by combination. Self-pretraining is performed based on the feature. The pretraining task is mainly for a classification task. A task architecture of 9 types of tags is used, and common fine-grained tag words of a relatively large scale are pretrained in combination with a large amount of easily obtained news data, to obtain a pretraining model of this application.

This application further provides a training solution of data staged training and parameter staged training. First, a large amount of unlabeled mining-based coarse surveillance data is used, and after an open-source parameter is loaded, further self-pretraining is performed, and a large amount of data training is performed on a global parameter (including a pretraining parameter and a task module parameter). Then, a classification module is newly added, and a coarse target task is constructed based on the labeled data and the pretraining model for training. And then, normal global parameter finetuning training is performed by using a small amount of labeled data. Finally, the pretraining parameter is frozen (a large number of parameters), and only a small quantity of newly added classification layer parameters are trained, to correspondingly debug a small quantity of parameters by matching small data. According to a multi-stage progressive learning method, a target classification task is gradually converged and can be finally relatively converged on training data of a small sample, thereby achieving good available accuracy and recall.

It may be learned from the foregoing that in this embodiment, a server may obtain at least one original sample content and labeled sample content, and obtain a classification model, where the labeled sample content carries an expected content type corresponding thereto, and the classification model includes a feature extraction module and a classification module. At least one target sample content is selected from the original sample content based on the expected content type corresponding to the labeled sample content and at least one content tag corresponding to the labeled sample content, and an expected content type corresponding to the target sample content is constructed. The target sample content is classified by using the classification model, to obtain an content type corresponding to the target sample content. Parameters of the feature extraction module and the classification module in the classification model are adjusted based on the content type and the expected content type corresponding to the target sample content, to obtain an adjusted classification model. Samples are selected from the target sample content and the labeled sample content, and at least one hybrid training sample set is constructed, where proportions of the target sample content and the labeled sample content in each hybrid training sample set are different. A training order of the hybrid training sample sets is determined based on the proportions corresponding to the hybrid training sample sets. The sample content in each hybrid training sample set is classified based on the training order by using the adjusted classification model, to obtain an content type of the sample content in each hybrid training sample set. Parameters of a feature extraction module and a classification module in the adjusted classification model are re-adjusted according to the content type, to obtain a re-adjusted classification model. The labeled sample content is classified by using the re-adjusted classification model, to obtain an content type of the labeled sample content. A parameter of a classification module in the re-adjusted classification model is updated according to the content type and the expected content type of the labeled sample content, to obtain a target classification model, where the target classification model is configured for classifying a content to be processed, to obtain a content type of the content to be processed.

In this application, a target sample content for training a target task may be mined by using a labeled sample content, so that the quantity of training samples is greatly increased. Accordingly, efficiency of obtaining a training sample can be improved, and not all training samples need to be labeled, thereby greatly improving training efficiency and reducing training costs. In addition, in this application, multi-stage training and learning may further be performed, so that a model can converge well, and classification accuracy of a target classification model obtained through training is higher.

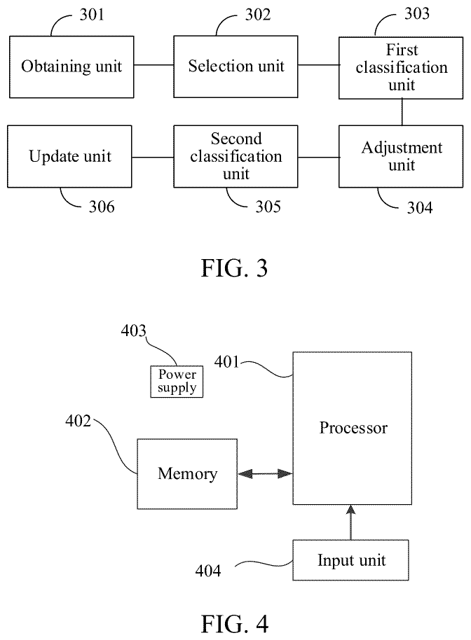

An embodiment of this application further provides a classification model training apparatus. As shown in FIG. 3, the classification model training apparatus may include an obtaining unit 301, a selection unit 302, a first classification unit 303, an adjustment unit 304, a second classification unit 305, and an update unit 306. The obtaining unit 301 is configured to obtain at least one original sample content and labeled sample content, and obtain a classification model, where the labeled sample content carries an expected content type corresponding thereto, and the classification model includes a feature extraction module and a classification module. The selection unit 302 is configured to select at least one target sample content from the original sample content based on the expected content type corresponding to the labeled sample content and at least one content tag corresponding to the labeled sample content, and construct an expected content type corresponding to the target sample content. The first classification unit 303 is configured to classify the target sample content by using the classification model, to obtain an content type corresponding to the target sample content. The adjustment unit 304 is configured to adjust parameters of the feature extraction module and the classification module in the classification model based on the content type corresponding to the target sample content and the expected content type corresponding to the target sample content, to obtain an adjusted classification model. The second classification unit 305 is configured to classify the labeled sample content by using the adjusted classification model, to obtain an content type corresponding to the labeled sample content. The update unit 306 is configured to update a parameter of a classification module in the adjusted classification model according to the content type corresponding to the labeled sample content and the expected content type corresponding to the labeled sample content, to obtain a target classification model, where the target classification model is configured for classifying a content to be processed, to obtain a content type of the content to be processed.

In some embodiments, the obtaining unit may include a model obtaining subunit, a similarity calculation subunit, an adjustment subunit, and a model construction subunit. The model obtaining subunit is configured to obtain a preset classification task model, and obtain a positive sample tag and a negative sample tag of the original sample content, where the preset classification task model includes a preset feature extraction module and a preset task module. The similarity calculation subunit is configured to: extract target feature information of the original sample content by using the preset feature extraction module; and calculate, by using the preset task module, a positive similarity between the target feature information and the positive sample tag, and a negative similarity between the target feature information and the negative sample tag. The adjustment subunit is configured to adjust a parameter of the preset classification task model based on the positive similarity and the negative similarity, to obtain a trained preset classification task model, where the trained preset classification task model includes a trained feature extraction module and task module. The model construction subunit is configured to construct the classification model based on a preset classification module and the trained feature extraction module.

In some embodiments, the preset task module includes a subtask module corresponding to at least one content category. The positive sample tag includes positive sample tags under content types. The negative sample tag includes negative sample tags under the content types. The similarity calculation subunit is specifically configured to calculate, for each content category, a positive similarity between a positive sample tag under the content category and the target feature information, and a negative similarity between a negative sample tag under the content category and the target feature information by using a subtask module corresponding to the content category. The adjustment subunit is specifically configured to: determine sub-loss functions corresponding to the content categories based on the positive similarity and the negative similarity; and adjust the parameter of the preset classification task model according to the sub-loss functions corresponding to the content categories, to obtain the trained classification task model.

In some embodiments, the selection unit may include a tag obtaining subunit, an establishment subunit, a sample selection subunit, and a construction subunit. The tag obtaining subunit is configured to obtain a content tag corresponding to the original sample content. The establishment subunit is configured to establish a mapping between the expected content type corresponding to the labeled sample content and the content tag corresponding to the labeled sample content. The sample selection subunit is configured to select, according to the content tag corresponding to the original sample content, a target sample content associated with the content tag of the labeled sample content from the original sample content. The construction subunit is configured to construct an expected content type of the target sample content based on the mapping and the expected content type of the labeled sample content.

In some embodiments, the first classification unit may include a feature extraction subunit and a prediction subunit. The feature extraction subunit is configured to perform feature extraction on the target sample content by using the feature extraction module, to obtain target feature information of the target sample content. The prediction subunit is configured to predict the content type of the target sample content based on the target feature information by using the classification module.

In some embodiments, the target sample content includes at least one content segment, and the content segment includes at least one content unit. The feature extraction subunit is configured to: perform key content extraction on the target sample content by using the feature extraction module, to obtain a first content sequence; perform attention encoding processing on content units in the first content sequence, to obtain attention encoding feature information corresponding to the content units in the first content sequence; perform content cropping processing on the target sample content, to obtain a second content sequence; perform sequence feature encoding processing on the second content sequence based on feature information of content units in the second content sequence, to obtain sequence feature information; and fuse the attention encoding feature information and the sequence feature information, to obtain the target feature information of the target sample content.

In some embodiments, the feature extraction subunit is configured to: determine, for each content segment in the target sample content, segment feature information of the content segment according to the feature information of the content units in the content segment by using the feature extraction module; fuse the segment feature information of the content segments of the target sample content, to obtain global feature information of the target sample content; select at least one target content segment from the content segments based on a similarity between the segment feature information of the content segments and the global feature information; and determine the first content sequence according to the target content segment.

In some embodiments, the feature extraction subunit is configured to: perform multi-head attention processing on the content units in the first content sequence, to obtain attention feature information corresponding to the content units; perform residual connection and normalization processing on the attention feature information corresponding to the content units, to obtain processed attention feature information corresponding to the content units; and perform full connection processing on the processed attention feature information corresponding to the content units, to obtain the attention encoding feature information corresponding to the content units in the first content sequence.

In some embodiments, the feature extraction subunit is configured to: perform a forward cropping operation on the target sample content, to obtain a forward content of the target sample content; perform a backward cropping operation on the target sample content, to obtain a backward content of the target sample content; and fuse the forward content and the backward content, to obtain the second content sequence.

In some embodiments, the feature extraction subunit is configured to: determine target attention encoding feature information in the attention encoding feature information corresponding to the content units in the first content sequence; fuse the target attention encoding feature information and the sequence feature information, to obtain content feature information of the target sample content; and obtain the target feature information of the target sample content according to a preset mapping matrix and the content feature information.

In some embodiments, the classification model training apparatus may further include a hybrid sample set construction unit, a training order determining unit, a third classification unit, and a re-adjustment unit. The hybrid sample set construction unit is configured to select samples from the target sample content and the labeled sample content, and construct at least one hybrid training sample set, where proportions of the target sample content and the labeled sample content in each hybrid training sample set are different. The training order determining unit is configured to determine a training order of the hybrid training sample sets based on the proportions corresponding to the hybrid training sample sets. The third classification unit is configured to classify the sample content in each hybrid training sample set based on the training order by using the adjusted classification model, to obtain an content type of the sample content in each hybrid training sample set. The re-adjustment unit is configured to re-adjust parameters of a feature extraction module and a classification module in the adjusted classification model according to the content type, to obtain a re-adjusted classification model.

In some embodiments, the re-adjustment unit may include a re-adjustment subunit and a circulation subunit. The re-adjustment subunit is configured to re-adjust the parameters of the feature extraction module and the classification module in the adjusted classification model according to the content type and an expected content type of the sample content in the target hybrid training sample set. The circulation subunit is configured to select a new target hybrid training sample set from the hybrid training sample sets according to the training order, and return to the operation of classifying a sample content in the target hybrid training sample set by using the adjusted classification model, to obtain an content type of the sample content in the target hybrid training sample set, to obtain a re-adjusted classification model.

It may be learned from the foregoing that in this application, a target sample content for training a target task may be mined by using a labeled sample content, so that the quantity of training samples is greatly increased. Accordingly, efficiency of obtaining a training sample can be improved, and not all training samples need to be labeled, thereby greatly improving training efficiency and reducing training costs. In addition, in this application, multi-stage training and learning may be performed. First, an overall parameter of a model is adjusted based on the mined target sample content. Then, a parameter of a classification module is adjusted by using the labeled sample content. Accordingly, a multi-stage progressive learning method enables the model to converge well, so that classification accuracy of a target classification model obtained through training is higher.

An embodiment of this application further provides an electronic device. FIG. 4 shows a schematic diagram of the structure of an electronic device according to an embodiment of this application. The electronic device may be a terminal or a server.

Specifically, the electronic device may include components such as a processor 401 of one or more processing cores, a memory 402 of one or more computer-readable storage media, a power supply 403, and an input unit 404. The structure of the electronic device shown in FIG. 4 does not constitute a limit to the electronic device. The server may include more or fewer parts than those shown in the figure, may combine some parts, or may have different part arrangements.

The processor 401 is a control center of the electronic device, is connected to various parts of the entire electronic device by using various interfaces and lines, and implements various functions of the electronic device and processes data by running or executing a computer program and/or module stored in the memory 402 and invoking data stored in the memory 402. The processor 401 may include one or more processing cores. In some embodiments, an application processor and a modem processor may be integrated into the processor 401. The application processor mainly processes an operating system, a user interface, an application, and the like. The modem processor mainly processes wireless communication. The foregoing modem may not be integrated into the processor 401.

The memory 402 may be configured to store a software program and a module. The processor 401 runs the software program and the module that are stored in the memory 402, to implement various functional applications and data processing. The memory 402 may mainly include a program storage area and a data storage area. The program storage area may store an operating system, an application required for at least one function (for example, a sound playback function and an image playback function), and the like. The storage data area may store data or the like created according to the use of the electronic device. In addition, the memory 402 may include a high speed random access memory, and may alternatively include a non-volatile memory, such as at least one magnetic disk storage device, a flash memory, or another volatile solid-state storage device. Correspondingly, the memory 402 may further include a memory controller, providing access of the processor 401 to the memory 402.

The electronic device further includes a power supply 403 for supplying power to the various components. In some embodiments, the power supply 403 may be logically connected to the processor 401 by a power management system, thereby implementing functions such as charging, discharging, and power consumption management by using the power management system. The power supply 403 may further include one or more direct current or alternating current power supply, a re-charging system, a power failure detection circuit, a power supply converter or inverter, a power supply state indicator, and any other components.

The electronic device may further include an input unit 404. The input unit 404 may be configured to receive entered numeric or character information and generate keyboard, mouse, joystick, optical, or trackball signal input related to user settings and function control.

Although not shown, the electronic device may further include a display unit, and the like. Details are not described herein again. Specifically, in this embodiment, the processor 401 in the electronic device may load, according to the following instructions, executable files corresponding to processes of one or more applications into the memory 402. The processor 401 runs the applications stored in the memory 402, to implement the classification model training method provided in this embodiment.

In this application, a target sample content for training a target task may be mined by using a labeled sample content, so that the quantity of training samples is greatly increased. Accordingly, efficiency of obtaining a training sample can be improved, and not all training samples need to be labeled, thereby greatly improving training efficiency and reducing training costs. In addition, in this application, multi-stage training and learning may be performed. First, an overall parameter of a model is adjusted based on the mined target sample content. Then, a parameter of a classification module is adjusted by using the labeled sample content. Accordingly, a multi-stage progressive learning method enables the model to converge well, so that classification accuracy of a target classification model obtained through training is higher.

All or some operations of the methods in the foregoing embodiments may be implemented by using computer-executable instructions, or implemented through the computer-executable instructions controlling relevant hardware. The computer-executable instructions may be stored in a computer-readable storage medium and loaded and executed by a processor.

In view of this, an embodiment of this application provides a computer-readable storage medium, having a plurality of computer-executable instructions stored. The computer-executable instructions are suitable to be loaded by a processor, to implement the operations in any classification model training method provided in this embodiment.

The computer-readable storage medium may include: a read-only memory (ROM), a random access memory (RAM), a magnetic disk, an optical disc, or the like.

Since the computer-executable instructions stored in the computer-readable storage medium may perform the operations in any classification model training method provided in this embodiment, advantageous effects that may be implemented by any classification model training method provided in this embodiment. The foregoing embodiments may be referred to for details. Details are not described herein again.

An embodiment of this application provides a computer program product. The computer program product includes computer-executable instructions. The computer-executable instructions are stored in a computer-readable storage medium. A processor of an electronic device reads the computer-executable instructions from the computer-readable storage medium. The processor executes the computer-executable instructions, so that the electronic device performs the method provided in various exemplary implementations of the foregoing aspect of classification model training.

The classification model training method and the related device provided in the embodiments of this application are described in detail above. The principles and implementation of this application are described by applying specific examples, and the descriptions of the embodiments are only used to help understand the method and core idea of this application. In addition, for a person skilled in the art, there will be changes in the specific implementations and the application scope according to the idea of this application. In conclusion, the content of this specification cannot be construed as a limitation to this application.

What is claimed is:

1. A classification model training method, performed by an electronic device, the method comprising:
obtaining at least one original sample content and labeled sample content, and obtaining a classification model, the labeled sample content carrying an expected content type, and the classification model comprising a feature extraction module and a classification module;
selecting at least one target sample content from the original sample content based on the expected content type corresponding to the labeled sample content and at least one content tag corresponding to the labeled sample content, and constructing an expected content type corresponding to the target sample content;
classifying the target sample content by using the classification model to obtain an actual content type corresponding to the target sample content;
adjusting parameters of the feature extraction module and the classification module of the classification model based on the actual content type corresponding to the target sample content and the expected content type corresponding to the target sample content, to obtain an adjusted classification model;
classifying the labeled sample content by using the adjusted classification model, to obtain an actual content type corresponding to the labeled sample content; and
updating a parameter of a classification module of the adjusted classification model according to the actual content type corresponding to the labeled sample content and the expected content type corresponding to the labeled sample content, to obtain a target classification model, the target classification model being configured for classifying a content to be processed to obtain a content type of the content to be processed.

2. The method according to claim 1, wherein the selecting at least one target sample content from the original sample content based on the expected content type corresponding to the labeled sample content and at least one content tag corresponding to the labeled sample content, and constructing an expected content type corresponding to the target sample content comprises:
obtaining a content tag corresponding to the original sample content;
establishing a mapping between the expected content type corresponding to the labeled sample content and the content tag corresponding to the labeled sample content;
selecting, according to the content tag corresponding to the original sample content, a target sample content associated with the content tag of the labeled sample content from the original sample content; and
constructing an expected content type of the target sample content based on the mapping and the expected content type of the labeled sample content.

3. The method according to claim 1, wherein the obtaining a classification model comprises:
obtaining a preset classification task model, and obtaining a positive sample tag and a negative sample tag of the original sample content, the preset classification task model comprising a preset feature extraction module and a preset task module;
extracting target feature information of the original sample content by using the preset feature extraction module;
calculating, by using the preset task module, a positive similarity between the target feature information and the positive sample tag, and a negative similarity between the target feature information and the negative sample tag;
adjusting a parameter of the preset classification task model based on the positive similarity and the negative similarity, to obtain a trained preset classification task model, the trained preset classification task model comprising a trained feature extraction module and task module; and
constructing the classification model based on a preset classification module and the trained feature extraction module.

4. The method according to claim 3, wherein the preset task module comprises a subtask module corresponding to at least one content category, the positive sample tag comprises positive sample tags under content types, the negative sample tag comprises negative sample tags under the content types;
the calculating, by using the preset task module, a positive similarity between the target feature information and the positive sample tag, and a negative similarity between the target feature information and the negative sample tag comprises:
calculating, for each content category, a positive similarity between a positive sample tag under the content category and the target feature information, and a negative similarity between a negative sample tag under the content category and the target feature information by using a subtask module corresponding to the content category; and
the adjusting a parameter of the preset classification task model based on the positive similarity and the negative similarity, to obtain a trained classification task model comprises:
determining sub-loss functions corresponding to the content categories based on the positive similarity and the negative similarity; and
adjusting the parameter of the preset classification task model according to the sub-loss functions corresponding to the content categories, to obtain the trained classification task model.

5. The method according to claim 1, wherein before the classifying the labeled sample content by using the adjusted classification model to obtain an actual content type of the labeled sample content, the method further comprises:
selecting samples from the target sample content and the labeled sample content, and constructing at least one hybrid training sample set based on the selected samples, proportions of the target sample content and the labeled sample content in each hybrid training sample set being different;
determining a training order of the hybrid training sample sets based on the proportions corresponding to the hybrid training sample sets;
classifying, based on the training order, the sample content in each hybrid training sample set by using the adjusted classification model, to obtain an actual content type of the sample content in each hybrid training sample set; and
re-adjusting parameters of a feature extraction module and a classification module in the adjusted classification model according to the actual content type, to obtain a re-adjusted classification model.

6. The method according to claim 5, wherein the classifying, based on the training order, the sample content in each hybrid training sample set by using the adjusted classification model, to obtain an actual content type of the sample content in each hybrid training sample set comprises:
determining, according to the training order, a target hybrid training sample set currently configured for training; and
classifying a sample content in the target hybrid training sample set by using the adjusted classification model, to obtain an actual content type of the sample content in the target hybrid training sample set; and
the re-adjusting the parameters of the feature extraction module and the classification module in the adjusted classification model according to the actual content type, to obtain a re-adjusted classification model comprises:
re-adjusting the parameters of the feature extraction module and the classification module in the adjusted classification model according to the actual content type and an expected content type of the sample content in the target hybrid training sample set;
selecting a new target hybrid training sample set from the hybrid training sample sets according to the training order; and returning to the operation of classifying a sample content in the target hybrid training sample set by using the adjusted classification model, to obtain an actual content type of the sample content in the target hybrid training sample set, to obtain a re-adjusted classification model.

7. The method according to claim 1, wherein the classifying the target sample content by using the classification model, to obtain an actual content type corresponding to the target sample content comprises:
performing feature extraction on the target sample content by using the feature extraction module, to obtain target feature information of the target sample content; and
predicting the actual content type of the target sample content based on the target feature information by using the classification module.

8. The method according to claim 7, wherein the target sample content comprises at least one content segment, and the content segment comprises at least one content unit; and
the performing feature extraction on the target sample content by using the feature extraction module, to obtain target feature information of the target sample content comprises:
performing key content extraction on the target sample content by using the feature extraction module, to obtain a first content sequence;
performing attention encoding processing on content units in the first content sequence, to obtain attention encoding feature information corresponding to the content units in the first content sequence;
performing content cropping processing on the target sample content, to obtain a second content sequence, and performing sequence feature encoding processing on the second content sequence based on feature information of content units in the second content sequence, to obtain sequence feature information; and
fusing the attention encoding feature information and the sequence feature information, to obtain the target feature information of the target sample content.

9. The method according to claim 8, wherein the performing key content extraction on the target sample content by using the feature extraction module, to obtain a first content sequence comprises:
performing, by the feature extraction module, the following processing: determining, for each content segment in the target sample content, segment feature information of the content segment according to the feature information of the content units in the content segment;
fusing the segment feature information of the content segments of the target sample content, to obtain global feature information of the target sample content;
selecting at least one target content segment from the content segments based on a similarity between the segment feature information of the content segments and the global feature information; and
determining the first content sequence according to the target content segment.

10. The method according to claim 8, wherein the performing attention encoding processing on content units in the first content sequence, to obtain attention encoding feature information corresponding to the content units in the first content sequence comprises:
performing multi-head attention processing on the content units in the first content sequence, to obtain attention feature information corresponding to the content units;
performing residual connection and normalization processing on the attention feature information corresponding to the content units, to obtain processed attention feature information corresponding to the content units; and
performing full connection processing on the processed attention feature information corresponding to the content units, to obtain the attention encoding feature information corresponding to the content units in the first content sequence.

11. The method according to claim 8, wherein the performing content cropping processing on the target sample content, to obtain a second content sequence comprises:
performing a forward cropping operation on the target sample content, to obtain a forward content of the target sample content;
performing a backward cropping operation on the target sample content, to obtain a backward content of the target sample content; and
fusing the forward content and the backward content, to obtain the second content sequence.

12. The method according to claim 8, wherein the fusing the attention encoding feature information and the sequence feature information, to obtain the target feature information of the target sample content comprises:
determining target attention encoding feature information in the attention encoding feature information corresponding to the content units in the first content sequence;
fusing the target attention encoding feature information and the sequence feature information, to obtain content feature information of the target sample content; and
obtaining the target feature information of the target sample content according to a preset mapping matrix and the content feature information.

13. An electronic device, comprising a memory and a processor, the memory having computer-executable instructions stored, and the processor being configured to run the computer-executable instructions in the memory, to perform a classification model training method, performed by the electronic device, the method comprising:
obtaining at least one original sample content and labeled sample content, and obtaining a classification model, the labeled sample content carrying an expected content type, and the classification model comprising a feature extraction module and a classification module;
selecting at least one target sample content from the original sample content based on the expected content type corresponding to the labeled sample content and at least one content tag corresponding to the labeled sample content, and constructing an expected content type corresponding to the target sample content;
classifying the target sample content by using the classification model to obtain an actual content type corresponding to the target sample content;
adjusting parameters of the feature extraction module and the classification module of the classification model based on the actual content type corresponding to the target sample content and the expected content type corresponding to the target sample content, to obtain an adjusted classification model;
classifying the labeled sample content by using the adjusted classification model, to obtain an actual content type corresponding to the labeled sample content; and
updating a parameter of a classification module of the adjusted classification model according to the actual content type corresponding to the labeled sample content and the expected content type corresponding to the labeled sample content, to obtain a target classification model, the target classification model being configured for classifying a content to be processed to obtain a content type of the content to be processed.

14. The electronic device according to claim 13, wherein the selecting at least one target sample content from the original sample content based on the expected content type corresponding to the labeled sample content and at least one content tag corresponding to the labeled sample content, and constructing an expected content type corresponding to the target sample content comprises:
obtaining a content tag corresponding to the original sample content;
establishing a mapping between the expected content type corresponding to the labeled sample content and the content tag corresponding to the labeled sample content;
selecting, according to the content tag corresponding to the original sample content, a target sample content associated with the content tag of the labeled sample content from the original sample content; and
constructing an expected content type of the target sample content based on the mapping and the expected content type of the labeled sample content.

15. The electronic device according to claim 13, wherein the obtaining a classification model comprises:
obtaining a preset classification task model, and obtaining a positive sample tag and a negative sample tag of the original sample content, the preset classification task model comprising a preset feature extraction module and a preset task module;
extracting target feature information of the original sample content by using the preset feature extraction module;
calculating, by using the preset task module, a positive similarity between the target feature information and the positive sample tag, and a negative similarity between the target feature information and the negative sample tag;
adjusting a parameter of the preset classification task model based on the positive similarity and the negative similarity, to obtain a trained preset classification task model, the trained preset classification task model comprising a trained feature extraction module and task module; and
constructing the classification model based on a preset classification module and the trained feature extraction module.

16. The electronic device according to claim 15, wherein the preset task module comprises a subtask module corresponding to at least one content category, the positive sample tag comprises positive sample tags under content types, the negative sample tag comprises negative sample tags under the content types;
the calculating, by using the preset task module, a positive similarity between the target feature information and the positive sample tag, and a negative similarity between the target feature information and the negative sample tag comprises:
calculating, for each content category, a positive similarity between a positive sample tag under the content category and the target feature information, and a negative similarity between a negative sample tag under the content category and the target feature information by using a subtask module corresponding to the content category; and
the adjusting a parameter of the preset classification task model based on the positive similarity and the negative similarity, to obtain a trained classification task model comprises:
determining sub-loss functions corresponding to the content categories based on the positive similarity and the negative similarity; and
adjusting the parameter of the preset classification task model according to the sub-loss functions corresponding to the content categories, to obtain the trained classification task model.

17. The electronic device according to claim 13, wherein before the classifying the labeled sample content by using the adjusted classification model to obtain an actual content type of the labeled sample content, the method further comprises:
selecting samples from the target sample content and the labeled sample content, and constructing at least one hybrid training sample set based on the selected samples, proportions of the target sample content and the labeled sample content in each hybrid training sample set being different;
determining a training order of the hybrid training sample sets based on the proportions corresponding to the hybrid training sample sets;
classifying, based on the training order, the sample content in each hybrid training sample set by using the adjusted classification model, to obtain an actual content type of the sample content in each hybrid training sample set; and
re-adjusting parameters of a feature extraction module and a classification module in the adjusted classification model according to the actual content type, to obtain a re-adjusted classification model.

18. The electronic device according to claim 17, wherein the classifying, based on the training order, the sample content in each hybrid training sample set by using the adjusted classification model, to obtain an actual content type of the sample content in each hybrid training sample set comprises:
determining, according to the training order, a target hybrid training sample set currently configured for training; and
classifying a sample content in the target hybrid training sample set by using the adjusted classification model, to obtain an actual content type of the sample content in the target hybrid training sample set; and
the re-adjusting the parameters of the feature extraction module and the classification module in the adjusted classification model according to the actual content type, to obtain a re-adjusted classification model comprises:
re-adjusting the parameters of the feature extraction module and the classification module in the adjusted classification model according to the actual content type and an expected content type of the sample content in the target hybrid training sample set;
selecting a new target hybrid training sample set from the hybrid training sample sets according to the training order; and returning to the operation of classifying a sample content in the target hybrid training sample set by using the adjusted classification model, to obtain an actual content type of the sample content in the target hybrid training sample set, to obtain a re-adjusted classification model.

19. The electronic device according to claim 13, wherein the classifying the target sample content by using the classification model, to obtain an actual content type corresponding to the target sample content comprises:
performing feature extraction on the target sample content by using the feature extraction module, to obtain target feature information of the target sample content; and
predicting the actual content type of the target sample content based on the target feature information by using the classification module.

20. A non-transitory computer-readable storage medium, the computer-readable storage medium having computer-executable instructions stored, the computer-executable instructions being suitable for being loaded by a processor, to perform a classification model training method, performed by an electronic device, the method comprising:
obtaining at least one original sample content and labeled sample content, and obtaining a classification model, the labeled sample content carrying an expected content type, and the classification model comprising a feature extraction module and a classification module;
selecting at least one target sample content from the original sample content based on the expected content type corresponding to the labeled sample content and at least one content tag corresponding to the labeled sample content, and constructing an expected content type corresponding to the target sample content;
classifying the target sample content by using the classification model to obtain an actual content type corresponding to the target sample content;
adjusting parameters of the feature extraction module and the classification module of the classification model based on the actual content type corresponding to the target sample content and the expected content type corresponding to the target sample content, to obtain an adjusted classification model;
classifying the labeled sample content by using the adjusted classification model, to obtain an actual content type corresponding to the labeled sample content; and
updating a parameter of a classification module of the adjusted classification model according to the actual content type corresponding to the labeled sample content and the expected content type corresponding to the labeled sample content, to obtain a target classification model, the target classification model being configured for classifying a content to be processed to obtain a content type of the content to be processed.
